(19) United States
(12) Patent Application Publication
(10) Pub. No.: US 2016/0350718 A1
(43) Pub. Date: Dec. 1, 2016

(54) SYSTEM FOR COUNSELING EMPLOYEES AND EMPLOYERS WITH REGARD TO EMPLOYER BENEFITS

(71) Applicant: Employee Network, Inc., Vestal, NY (US)

(72) Inventor: Gene Raymondi, Vestal, NY (US)

(73) Assignee: Employee Network, Inc., Vestal, NY (US)

(21) Appl. No.: 14/725,408

(22) Filed: May 29, 2015

(51) Int. Cl. G06Q 10/10

(52) U.S. Cl. CPC G06Q 10/1057

(57) ABSTRACT

A system for counseling employees and employers with regard to employer benefits. The system has a processor with associated memory storage device and a computer display operatively connected thereto. The system includes a wheel of life graphic displayed on the computer display. The wheel of life has a number of life event categories, each one of which is annotated with text, and customized to a specified user. The system also has a database of benefits stored in the memory storage device. The benefits are provided by an employer for the specified user. A second database of entities is also stored in the memory storage device. These entities provide external services to support the life events, so that at least a portion of the benefits and community resources and at least a portion of the entities are linked to each of the life event categories. A mobile application is based on the concepts and design of the processor with the associated memory storage device and computer display. The system also includes employer specific Human Capital Analytics reports created through a process of administering employer specific survey instruments, analyzing data compiled from the surveys and other employer provided documents, and creating an integrated benefits solution.

### FIELD OF THE INVENTION

This invention relates to systems for counseling employees and employers with regard to employer culture and benefits and, more particularly, to a system for assessing benefit connectivity and culture as well as providing benefit counseling having a wheel of life graphic displayed on a computer display, the wheel of life having life event categories annotated with text and customized to a specified employee.

### BACKGROUND OF THE INVENTION

Many employers provide employee benefits, plans and programs (hereinafter referred to as “benefits”), to their employees as part of their total compensation packages. These benefits may include employer provided personnel benefits, health insurance benefits, disability insurance benefits, life insurance benefits, pension benefits, retirement benefits, stock option programs, profit sharing programs, employee savings accounts and plans, employee credit union accounts and services, employee discount programs, and other valuable benefits and programs.

The benefits provided to employees can be so numerous and complex that the employee may not be aware of them or know how to take advantage of them. In other instances, the providers of the benefits may be difficult to deal with or may not be easily accessible to the employee. In these instances, the employee will have to expend effort and time in order to obtain a benefit or information about a benefit.

Frustration may result when benefits may be too difficult or complicated to obtain or to gain access to, especially when benefits are not easily understood or when benefits providers are difficult to deal with or to communicate with. Given the fact that most employees seek benefits during the workday, company or employer time and resources are expended by the employee in attending to benefits matters, usually at the employer's expense.

The offering and the administration of employee benefits typically requires that a vast amount of diverse and complex information be managed, administered, and be constantly monitored by administrators. Employees must also be assisted in their efforts to claim or gain access to their benefits and/or to information related thereto.

As can be easily seen, great amounts of time, money and resources are expended in offering and administering an employee benefits plan or program. Even greater amounts are expended when benefits and/or benefits information are not readily available to, or accessible by, the employee.

In the past, employers had group benefit plans designed to meet the needs of all employees. The problem is that employers have a diverse group of employees having a wide range of different needs. For example, an employer typically has older employees near retirement, middle aged employees with families, single employees, and younger employees that are just starting their careers. As a result, an employer's group benefits plan needs to include a wide variety of insurance and other benefits in order to meet the needs of all of its employees. The old model of group plans is inefficient and often more expensive than necessary. The employer might enroll each employee in the available benefits, even though the employee's needs were not the same.

Increasing benefit costs and reduced available funding have forced employers to shift responsibility for retirement planning and insurance benefits to employees. Employees are offered choices today that allow them to select benefits appropriate to their own situations, but are required to pay for all or part of the costs of the benefits. This introduction of voluntary employee paid benefit plans has resulted in a blurring of the delineation between individual and group products.

As costs have been shifted to employees, employers have endeavored to improve their voluntary benefit packages by incorporating more benefits, including non-traditional insurance benefits and non-insurance benefits. Examples of such benefits that are being offered by employers through payroll deduction today include pre-paid legal services, mortgage refinancing, auto and homeowners insurance, and “pricing club” type benefits such as discount computers.

Computerized systems for administering group benefit plans based on the traditional model are not sufficiently flexible to meet the requirements of the changing benefits marketplace. Such systems maintain information about the insurance products, but not about the employee's benefit plan/package.

Similarly, systems assessing the culture, employee satisfaction, and benefits satisfaction/utilization are not sufficiently flexible to meet the requirements of the changing workforce and benefits marketplace. Such systems generally focus solely on one component, such as culture, while excluding the rest from consideration.

Therefore, there is a need for a system that more efficiently manages the creation, maintenance, and archiving of benefit data. There is a further need for a system of administering insurance products, non-insurance products, and benefit plans within the same system. There is also a need for a system that is customizable without extensive reprogramming. There is a need for a system that permits the administrator to choose from a wide variety of benefit options in recording the specific employer's benefit package and its employees' choices, without requiring modification of the system's record designs. There is a need for a system that maintains information only at the level at which it is actually needed, allowing the administrator to select this level differently for different employer groups, for different benefit packages within an employer group, and for different classes of information within a package. There is a need for a system that minimizes the need to modify program code to accommodate modifications or changes to benefit plans. There is need for a system that links employee life event needs to benefits and community resources which will assist and address these needs. There is a need for a system designed to engage employees with their benefits using gamification and incentives. There is a need for a computer system that permits selection of methods for assessing, measuring, and processing benefits information, performance, and utilization from a wide variety of available methods. Finally, there is a need for a system which assesses benefit satisfaction/utilization/connectivity, company culture, and employee satisfaction as a whole, and uses data obtained through individually tailored survey instruments to design integrated benefit solutions offered in a company specific Human Capital Analytics report.

### DESCRIPTION OF RELATED ART

U.S. Pat. No. 7,305,347 issued to Joao for “Apparatus and Method for Providing Employee Benefits and/or Employee Benefits Information,” on Dec. 4, 2007, describes a computer-implemented method, including receiving a request or claim for an employee benefit via, on, or over, the Internet, processing the request or claim for an employee benefit with a first processing device or a second processing device accessed via, on, or over, or which operates on or over, the Internet, determining with the first processing device or with the second processing device whether the employee benefit requested in the request or claim for an employee benefit is to be provided, generating a message in response to the request or claim for an employee benefit, and transmitting the message to a communication device associated with at least one of the employee, the benefit beneficiary, an employer, and a benefit administrator, via, on, or over, the Internet.

U.S. Published Patent Application no. 2002/0069077 on application filed by Brophy, et al. for “Computerized System for Customizing and Managing Benefits,” published Jun. 6, 2002, discloses a computer system for administering employee benefits. The computer system comprises a first tier that includes a plurality of users. At least one user is a workstation having a processor and memory. At least one other user is a system processing means. The workstation is configured for inputting rules into the computer system. The rules are for controlling the computer system. The system processing means is configured to generate and execute transactions based upon the rules. A second tier includes memory configured to store the rules. The rules are organized into tables within the memory of the second tier. A third tier includes memory configured to store benefit data. The benefit data is organized into tables in the third tier memory. The benefit data can be manipulated only by the system processing means executing the rule-based transactions.

### SUMMARY OF THE INVENTION

In accordance with the present invention, there is provided a system for counseling employees and employers with regard to employer benefits. The system has a processor with associated memory storage device and a computer display operatively connected thereto. The system includes a wheel of life graphic displayed on the computer display. The wheel of life has a number of life event categories, each one of which is annotated with text, and customized to a specified user. The system also has a database of benefits and community resources stored in a memory storage device. The benefits are provided by an employer for the specified user. A second database of entities is also stored in the memory storage device. These entities provide external services to support the life events, so that at least a portion of the benefits and community resources and at least a portion of the entities are linked to each of the life event categories.

It is therefore an object of the invention to provide a mechanism by which employees can be guided to learn of specific benefits, whether through employees self-directed use of a member portal or self-directed use of a mobile application or through trained specialists utilizing administrative software working with employees telephonically.

It is a further object of the present invention to provide a system that permits searchable benefits organized by life events.

It is another object of the present invention to provide a system by which employees can see information on their own computer screen.

It is yet a further object of the present invention to provide a system capable of listing programs that are not yet participating.

It is yet a further object of the present invention to provide a system that links and provides information about available community resources to life events experienced by employees

It is another object of the present invention to provide a system that provides gamification and incentives to employees who use the system.

It is yet a further object of the present invention to provide a system that has frequently asked questions (FAQs) with answers that link to relevant documents.

It is yet a further object of the present invention to provide a system for assessing employer culture, employee satisfaction, and benefit satisfaction/utilization/connectivity through use of tailored survey instruments and an individually tailored Human Capital Analytics report.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a high level symbolic diagram of common categories of life events available to an employee in accordance with the invention;

FIG. 2 is a screen shot of an administrative control panel;

FIG. 3 is a screen shot of a member portal;

FIG. 4 is a block diagram of the components of the inventive system;

FIG. 5 is a flow chart of the process of creating an employer specific Human Capital Analytics report through administering employer specific survey instruments and analyzing the data compiled from said surveys and other employer provided documents in the inventive system;

FIG. 6 is a flow chart of the process followed to create and customize a benefit information line, benefit information portal, and administrative control panel for employees and employers using the inventive system;

FIGS. 7a through 7ii are screen shots of a mobile application displayed on a cell phone;

FIGS. 8a through 8dd are screen shots of a mobile application displayed on a tablet; and

FIG. 9 shows a Table of Contents, reflecting data from survey instruments and employer provided documentation, for a Human Capital Analytics Report.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

The invention is a system for counseling employees and employers with regard to benefits. The system has a processor with associated memory storage device and a computer display operatively connected thereto. The system includes a wheel of life graphic displayed on the computer display. The wheel of life has a number of life event categories, each one of which is annotated with text, and customized to a specified user. At least a portion of the benefits, as well as community resources, are linked to each of the life event categories.

For purposes of this description, the following terms have meanings defined as follows:

Administrative Control Panel (ACP): A confidential and proprietary benefit integration software that compiles information about members' employee benefit offerings and guides Benefit Information Specialists (BISs) through the exploration of eligible members' “life events” and connects them to the benefits provided and selected by members' employers. BalanceBenefits HRDirect may or may not be included as part of the Administrative Control Panel, depending on employer preference.

Benefit Integration: The coordination of any combination of employee benefits that were previously separate from one another, in a way that they are monitored, managed, and processed in cooperation with each other.

Benefit Information Line (BIL): A toll free, 24/7, confidential telephone line which connects eligible members to live assistance from knowledgeable and specially trained Benefit Information Specialists about benefits provided and selected by members' employers and how benefits can assist with members' life events.

Benefit Information Portal (BIP): A confidential and proprietary web-based benefit integration software that provides eligible members with access to benefits information, supports and guides eligible members through exploring and identifying “life events”, and connects members to related benefits and community resources compiled together to provide real solutions.

Benefit Information Specialist (BIS): An experienced, knowledgeable professional specially trained in the facilitation of benefits related information, navigation (which may include enrollment support) of employer sponsored benefits, assessment of eligible members' benefit needs through identifying life event(s), and the identification and recommendation of supporting benefits and complementary external services to assist with life event(s).

Benefit Information Technician (BIT): An experienced, knowledgeable professional trained to customize, update, test, and modify benefits information, life events, eligible members' demographics, and employer information contained in the Administrative Control Panel, BalanceBenefits HRDirect, and Benefit Information Portal.

Employee: A user of the inventive system who may be a full time, part time, direct, or contract employee.

Employer: An organization that employs the employee. The organization may be a partnership, a firm, a club, an association, a consortium, or a for-profit or not-for-profit company or corporation.

Gamification: The process of applying game design to an activity or task in order to motivate eligible members to engage in the gamified activity or task.

BalanceBenefits HRDirect (HRD): Software added to the Administrative Control Panel, which compiles information about eligible members' benefit choices, designed for human resource professionals to verify and update members' benefit selections, notify members about important benefits information, award prizes for points earned and redeemed by employees, and update benefits information.

Human Capital Analytics Report (HCAR): A written assessment which identifies human capital needs and existing corporate culture as well as employees' job satisfaction, understanding, perception and utilization of benefits. This assessment serves as a tool for leadership to propel the company forward while meeting essential recruitment and retention goals.

Human Capital Design Team (HCD team): A team of independent human resources consultants experienced in employee benefits package design and assessment who work collaboratively with the Integrated Benefits team in recommending integrated benefits solutions across multiple industries and diverse employee populations.

Integrated Benefits Report (IBR): A complete written report providing individualized recommendations which outlines benefits and complementary external resources designed to support each eligible member with specific life events or concerns.

Integrated Benefits Analytics Report (IBA): An annual report comparing and correlating benefit utilization between benefit vendors selected by an employer, factoring in global workforce trends and pertinent human resource and employer concerns, and providing recommendations to support strategic goals and meet identified human capital needs.

Integrated Benefits Team (IB team): A team of internal integrated benefits specialists, bringing decades of interdisciplinary experience in the areas of communication strategies, employee benefits, healthcare, human resources, integrated technologies, law, nursing, research, social work, and teaching, who work collaboratively in designing integrated benefits solutions contained within Human Capital Analytics reports.

Integrated Life Services: An integrated benefits service which integrates elements of traditional employee assistance and work/life programs with benefits specialists and trained health coaches for an integrated approach to delivering a high quality service that eligible members can turn to with whatever their needs are.

Knowledge Point: A source, such as the Benefits Information Line or Benefits Information Portal, where eligible members can go to access information about their entire benefits package.

Life Event: Any significant step, event, or milestone a person may experience during their lifetime, including but not limited to marriage, divorce, birth of a child, retirement, milestone birthday, or purchase of a house.

Return on Integration (ROI): After implementing an integrated benefits solution, employers may experience a higher return on investment on their benefit dollars through increased benefit utilization, increased employee engagement and productivity, decreased employee turnover, and a heightened ability to recruit highly talented employees.

Super Administrator: A highly trained Benefit Information Specialist trained on multiple employee benefit packages and able to access, modify, and provide information about all customized employer Benefit Information Portals, Administrative Control Panels, and BalanceBenefits HRDirect.

Vendor: An organization that provides services to an employee; sometimes called a benefit provider.

Wheel of Life: A gamified application, contained within the Benefits Information Portal, Administrative Control Panel and Mobile Application, where members or BIS select pertinent life events which are then linked to benefits and community services to support these life events. The Wheel of Life need not be circular, as depicted in the drawings, but can be any graphical shape or concept that conveys the same or analogous information shown in the description herein below.

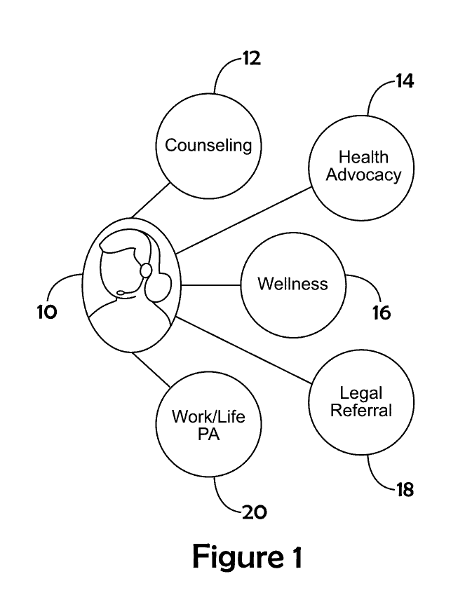

Referring now to FIG. 1, there is shown a high level symbolic diagram of common categories of life experiences available to an employee in accordance with the invention. An employee 10 may avail him/herself of: counseling 12, including but not limited to stress management or grief counseling; health advocacy 14, including but not limited to insurance coverage or care coordination; wellness 16, including but not limited to stress management or other participation requirements; legal referral 18, including but not limited to living wills, estate planning, or testamentary instruments; work/life personal assistant (PA), including but not limited to funeral coordination; and other categories, not shown, but within the scope of the invention.

Logging into Benefit Information Specialist (BIS) Administrative Control Portal

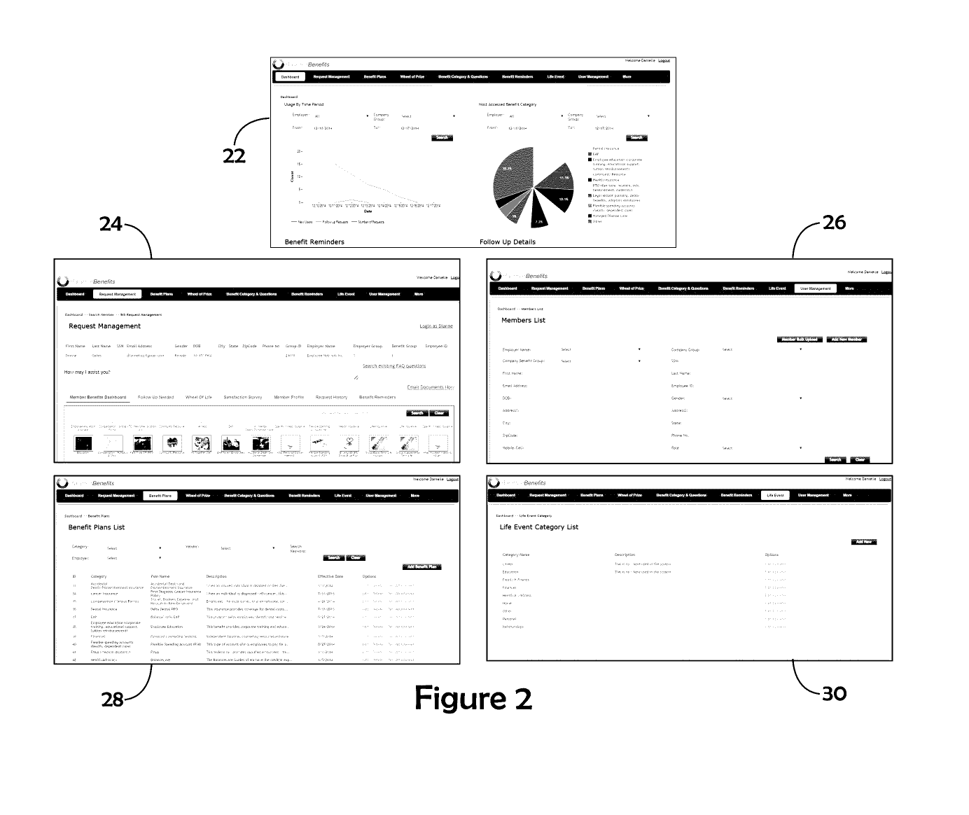

With reference to FIG. 2, the Benefit Information Specialist (BIS) Administrative Control Portal 22 is operatively connected to a Request Management module 24, a User Management module 26, a Benefit Plans module 28, and a Life Event module 30, as shown. Administrative Control Portal 22 serves several purposes which include:
Recording and storing information obtained and discussed during calls from and online chats with employees.
Assisting the BIS in providing a thorough assessment of each employee caller's benefit needs and in identifying pertinent life events.
Assisting the BIS in providing a consistent experience for each employee caller.
Customizing a web portal for each employer company to reflect the unique needs and benefits providing for their human capital.
Obtaining and reporting metrics for each employer company about general usage of the web portal by employees, access and understanding of benefits by employees, life events, and assessment/referral information provided to employees.

No specific employee information is provided to the employer other than initial demographics and benefit choices. In order to access this web portal, the Benefit Information Specialist first accesses the BIS Administrative Control Portal 22. A user name and password is assigned to each BIS to allow them to access this web portal.

### Locating and Verifying Employee Caller Demographics

After obtaining the caller's name, the BIS can retrieve the employee caller profile information by entering the “Request Management” tab/screen 24 and utilizing the “search” button therein. If the employee is not found through a search, the BIS can add the employee caller into the database by typing the information in and clicking on the “Add Member” link.

After locating the employee, the BIS should verify the name of the employer listed in the profile as well as the date of birth.

### Completing the Employee Caller Profile

If the employee is employed with a client company, their profile should already be filled out when the BIS reviews it in the “Request Management” screen 24. If not, the BIS can create and complete a profile for the employee by clicking on the “add” button on the screen.

### Handling an Employee Caller Request for Benefit Information

Once the BIS has verified the employee's date of birth, employer, and contact information, the BIS is ready to address the employee's request.

A request made by an employee can fall into several different types of categories which require different handling by the BIS. These categories include:
specific request for benefits information (e.g., how much is the co-pay under my health insurance plan for surgery)
general request for benefits information (e.g., I need to get eye surgery, do I have a benefit which covers this)

Sometimes an employee caller may present a life event instead of identifying a need for benefits information during the initial call. Where the employee caller appears distraught or requests assistance outside of benefits information, the BIS should work with the clinical staff in order to effectuate a transfer to an appropriate clinician for assessment prior to working on the benefits information request. Situations where a transfer to a clinician are appropriate include:
Employee caller mentions or threatens suicidal behavior of any kind;
Employee caller mentions or threatens homicidal behavior of any kind;
Employee caller mentions or threatens dangerous or illegal activity, such as criminal behavior at the worksite or offsite;
Employee caller mentions or threatens child or elder abuse/neglect.

### Specific Request

When an employee makes a specific request for benefits information, the BIS should:

1. Verify name of benefit plan with employee then select and click on benefit type under the “Member Benefit Dashboard.

2. Enter request under “How May I Assist You” then hit the “return” button. Make sure to enter the plan name, plan information and nature of the request under the “Call Summary” section.

3. Select and click on the benefit type again under the “Member Benefit Dashboard” to obtain requested benefit plan information.

4. Review summary of plan information provided; if further detail needed to answer question, click on “View Document” on the bottom of the “Plan Details” section to review the pdf.

5a. If the information requested is located in the summary or pdf, the BIS tells the caller that the information requested has been located. Provide a direct quote of the pertinent information contained in the summary or pdf. Document exactly what information was provided to the employee caller in the “Call Summary” section.

5b. If the information requested is not located in the summary or pdf, the BIS tells the employee that the benefit provider will be contacted about the request. Offer to initiate a conference call or offer to conduct research for the requested information. If employee wants research done, tell him or her that documentation, including but not limited to a release of information and HIPAA, will be submitted via email to allow employee caller's personal information to be exchanged between the Company managing the program and the benefit provider.

6. The BIS tells caller that the requested information highlighted in the pdf will be emailed to him or her within two days.

7. Email requested information to caller. If needed and agreed upon by the caller, the BIS initiates a conference call with the benefit provider and attempts to meet the caller's request through the conference call.

If the employee does not need to or does not wish to speak to the benefit provider, the BIS begins to create an Integrated Benefits Report, utilizing the Wheel of Life, 23 with the caller. If, however, the employee does not wish to create an Integrated Benefits Report, the BIS concludes the call.

### General Request

When an employee makes a general request for benefits, the BIS should immediately focus on the request presented by taking the following steps:

1. Ask employee which benefit plan(s) he or she is inquiring about. If employee is not certain, you can review the Member Benefits Dashboard screen and select the most likely benefit plan(s).

2. Verify the name of benefit plan(s) with and select and click on benefit type under the “Member Benefit Dashboard”.

3. Enter request in the “Request” section under “How May I Assist You” then hit the “return” button. Make sure to enter the plan name, plan information and nature of the request under the “Call Summary” section.

4. Select and click on the benefit type again under the “Member Benefit Dashboard” to obtain requested benefit plan information.

5. Review summary of plan information provided; if further detail needed to answer question, click on “View Document” on the bottom of the “Plan Details” section to review the pdf.

6a. If the information requested is located in the summary or pdf, tell the employee that the information requested has been located. Provide a direct quote of the pertinent information contained in the summary or pdf. Document exactly what information was provided to the employee caller in the “Call Summary” section.

6b. If the information requested is not located in the summary or pdf, tell the employee that the benefit provider will be contacted about the request. Offer to initiate a conference call or offer to conduct research for the requested information. If the employee agrees to a conference call, initiate the conference call with the benefit provider and seek to resolve the employee inquiry. If the employee requests to have research done, tell him or her that documentation, including but not limited to a release of information and HIPAA, will be submitted via email to allow employee caller's personal information to be exchanged between the Company managing the program and the benefit provider.

7. Tell employee caller that the requested information highlighted in the pdf will be emailed to him or her within two days.

8. Present the Integrated Benefits Report opportunity, utilizing the Wheel of Life 23 with the employee and engage in this process.

### Utilizing the Wheel of Life and Generating an Integrated Benefits Report

After an employee has made a benefit information request, the BIS has an opportunity to determine whether the employee has any life event needs, which may or may not be related to the request, for which benefits may be recommended. Life events are ordinary events which occur in many people's lives, which can include:
Marriage/domestic partnership;
Divorce;
Retirement from a job;
Traveling;
Buying or selling a home;
A lifestyle change, such as starting martial arts training or a vegetarian diet.

An employee may have one or more life events occurring simultaneously; often the employee is not aware of the benefit and community resources available to him or her which may assist with these life event(s).

For example, referring now to FIG. 1, Jane 10 has just found out that her husband has been diagnosed with late stage cancer, with only palliative treatment recommended. Obviously she is extremely distraught about the diagnosis, with many worries, fears, and concerns. Jane has access to many benefits which can assist her with this traumatic and difficult life event, some of which she may be completely unaware of. The chart of FIG. 1 illustrates how the benefits recommended by a BIS, after a diligent assessment of the employee's needs, can assist an employee on multiple levels.

Jane's initial request for information about hospice coverage was met and the BIS conducted a life event inventory with her. The following benefits were recommended:
Health Advocacy 14: Some of Lucy's stress was related to insurance coverage for her husband's illness and his care coordination. Her health advocacy program was able to resolve these issues for her.
Legal 18: She was also referred to her free legal consultation, which assisted her in setting up her husband's will as well as a prepaid burial account.
Wellness 16: As all the stress was wearing Jane down physically, she was directed to her wellness benefit, which helped her make healthy nutrition and exercises choices to keep herself strong.
Work/Life 20: After her husband passed away, Jane was referred to her work/life benefit, where her Personal Assistants helped research funeral arrangements.
EAP 12: Jane received eight sessions of counseling which helped her work through her grief and implement stress management techniques to help her through her husband's illness and death.

Her BIS, who had been advocating and managing her case in its entirety, also authorized additional counseling sessions to help Jane deal with her ongoing grief after her husband passed away.

### Explaining the Wheel of Life and Integrated Benefits Report

In speaking with an employee about the Wheel of Life 23 and Integrated Benefits Report, a BIS would begin by explaining about the value of this tool and the process for administering this.

After the BIS has entered the request information into the “How May I Assist You” box and the call information into the “Call Summary” box on the “Request Management Screen”, the BIS moves into the Integrated Benefits Report tab to access the Wheel of Life and the BIS can guide the employee through the life event category and subcategory questions.

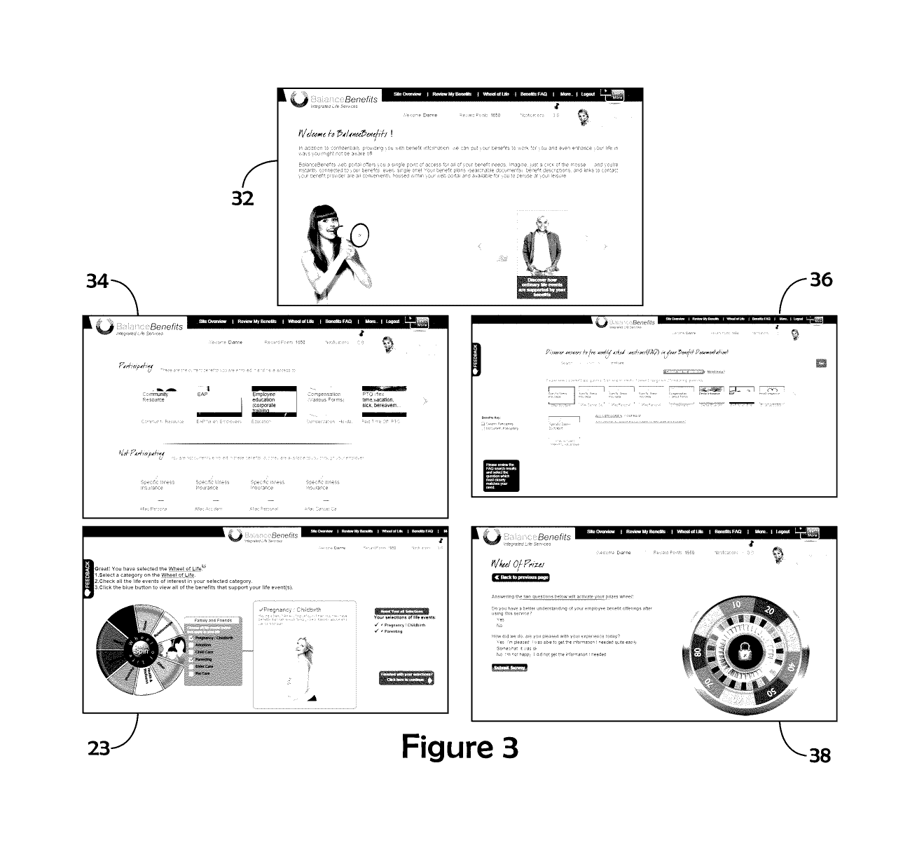

FIG. 3 is a screen shot of a member portal comprising the member portal 32 itself, operatively connect to a Review of My Benefits module 34, a Benefits FAQ module 36, the Wheel of Life module 23, and a general module which includes the Wheel of Prizes, module 38. The member portal is accessed by the employee directly.

The Benefits FAQ module 36 provides answers to frequently-asked questions and also provides links to appropriate documents in which the answer appears. This way, the employee may reference the source document immediately for more details.

The Wheel of Prizes module 38 is used to provide incentives to employees using the member portal who are often not familiar with all benefits for which they qualify or who have not taken advantage thereof. The Wheel of Prizes module 38 offers the prizes from selected vendors to the employee after achieving certain point levels.

As any category on the Wheel of Life 23 is chosen by the employee or administrator clicking on it, the graphics displayed on the remainder of the screen can change in real time, thus guiding the employee along the appropriate path based on his or her selection of a life event.

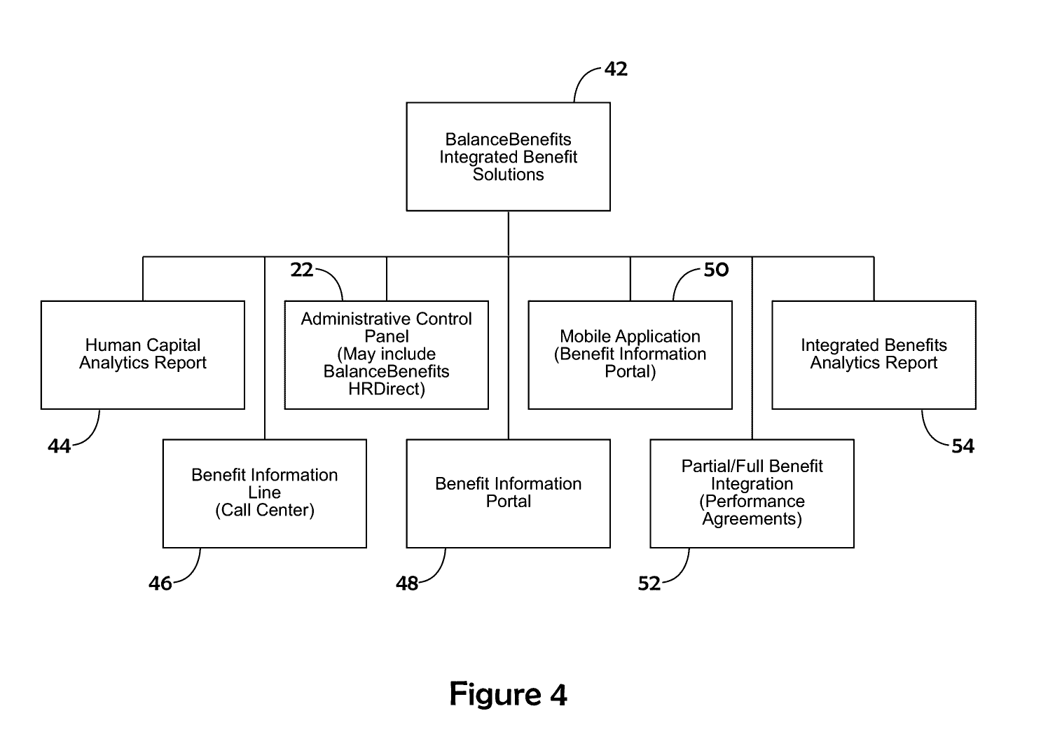

FIG. 4 is a block diagram of the components of the inventive system. The Integrated Benefit Solutions 42 is a cohesive, unitary module consisting of a Human Capital Analytics Report 44, a Benefit Information Line 46, the Administrative Control Panel 22, a Benefit Information Portal 48, a Mobile Application 50, a Partial/Full Benefit Integration 52, and an Integrated Benefits Analytics Report 54. The Benefit Information Portal 48 is displayed on the employee's screen.

### Administering the Wheel of Life

The BIS goes through each of the nine categories, with subcategories with the employee. Upon completion of the life event inventory, the BIS should click the “Build Integrated Report” button. When the report is complete, the BIS can choose to view the Report or email the report to the caller by clicking the email report button.

### Creating and Reviewing the Integrated Benefits Report

Upon completion of the Life Event Inventory, the BIS should click the “Build Integrated Report” button. When the report 54 is complete, the BIS can choose to view the report via the link below or email the report to the caller, step 82, by clicking the email report button.

Each life event identified by the caller will appear on the left hand side of the screen with the recommended benefits appearing on the right hand side. Employees will be able to review the full integration via email as well as plan information for any of the benefits recommended.

Results of the report, together with supporting documentation, can be obtained in different ways. In order to view the Benefit Integration Report 42, the BIS simply clicks on the “View Integration Report” button on the top center of the screen. The BIS can also email the integration report directly to the employee, step 82, by checking the “Email Integration Report” button located on the top left hand side of the screen. Finally, the BIS can view any of the benefit plan descriptions by clicking on the appropriate benefit icon in the center of the screen; the benefit pdf can be emailed to the client by checking the “email” box centered over each benefit icon.

Once the BIS has reviewed the report 54 with the caller, the BIS moves on to recording the follow up steps taken to handle the call, together with administering the Satisfaction Survey.

### Administering the Satisfaction Survey

After fulfilling the employee caller's request for benefits information, the BIS should administer the satisfaction survey and begin to conclude the call.

### Locate a Past Request

Past requests are stored in the “Request History” tab, which is located in the middle of the “Request Management” Screen 24 (FIG. 2). Simply click on the request, which is archived by date called, and the BIS will be able to pull up the Integrated Benefit Report generated on that date.

Once the request is reopened, enter any additional instructions or information in the request box and click on the “email” button to email it to the employee.

### Handling Questions Not Related to BalanceBenefits

Counseling—If a client requests counseling through the EAP, check to see if they have a file in our EAP database. If they have a file, confirm their demographic information and save the file if any changes needed to be made. If they do not have a file, create a new one and fill out their basic demographic information that is needed. All demographic information goes in the standard fields, the last 4 digits of their SS number, their marital status, and the name of the company that they work for. After completing this, transfer them to an available Care Manager. If no one is available to take the call, pass the call to our vendor Work Place Options. Wait for an agent to answer the phone and tell them you're passing a call to them from the Company. Give them the client's information.
Payroll—Clients occasionally confuse us with their Payroll company. If they are calling with questions about their paycheck, FSA deferments or 401 k options, have them call the Payroll company directly to get that information.
BalanceHealth/Wellness—Transfer the client to a Wellness Coach if they are available. If they are not, transfer the call to the group voice mail and email the Wellness Coach with the client's information. If a call comes in after hours or on the weekend, apologize to the client and let them know a Wellness Coach will contact them within 24 business hours. If it is during business hours, the client should hear back the same business day.
BalanceCare—If someone calls looking for help with an insurance issue (claims, what is covered under their plan, etc.), you should first check to see if they are in our EAP database as a client. If they are not, ask the client if they get our services through their Payroll Company. If either of the above are true, assume that the client is a BalanceCare client. Fill in an Afterhours BalanceCare Form.

As seen from the description hereinabove, the inventive system connects one or more benefits and community resources to each life event specified by an employee, reducing the chance that an employee will overlook particular benefits to one experiencing his or her life event(s).

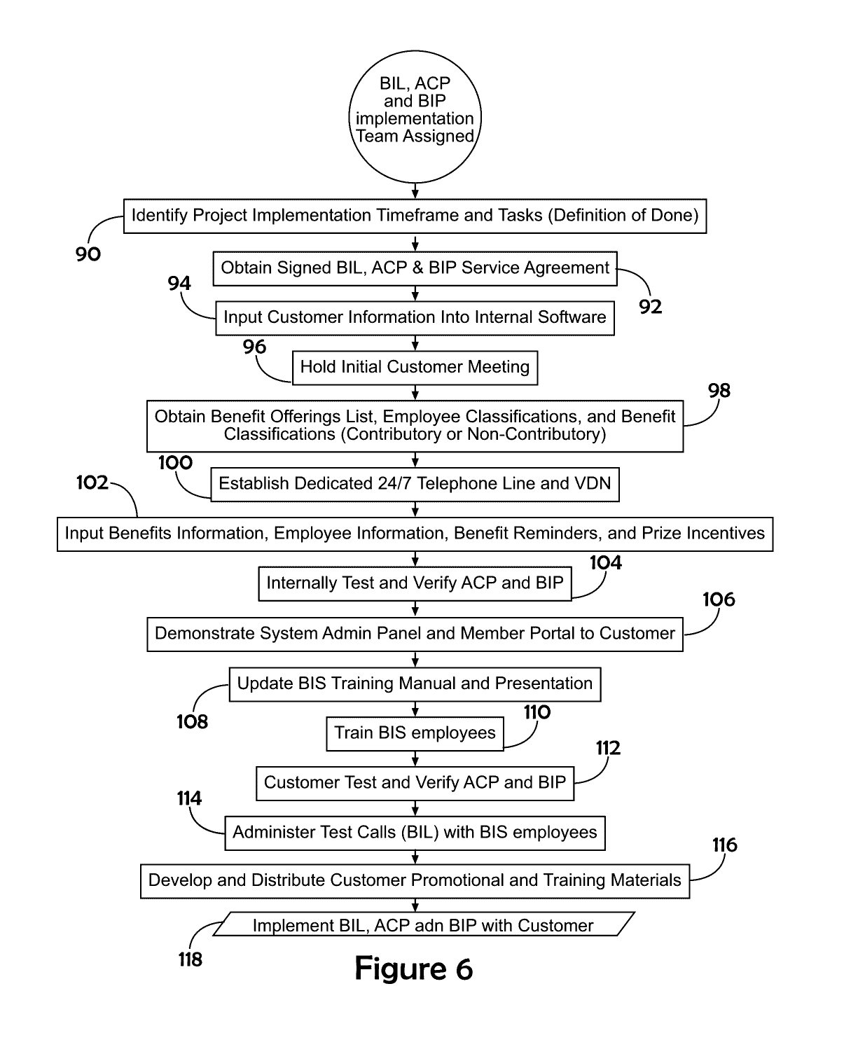

FIG. 6 is a flow chart of the process followed by an administrator in the course of operating the inventive system. Each of the steps of the process, steps 90-116, contributes to the end result, implementing BIL, ACP, and BIP with the employee, step 118.

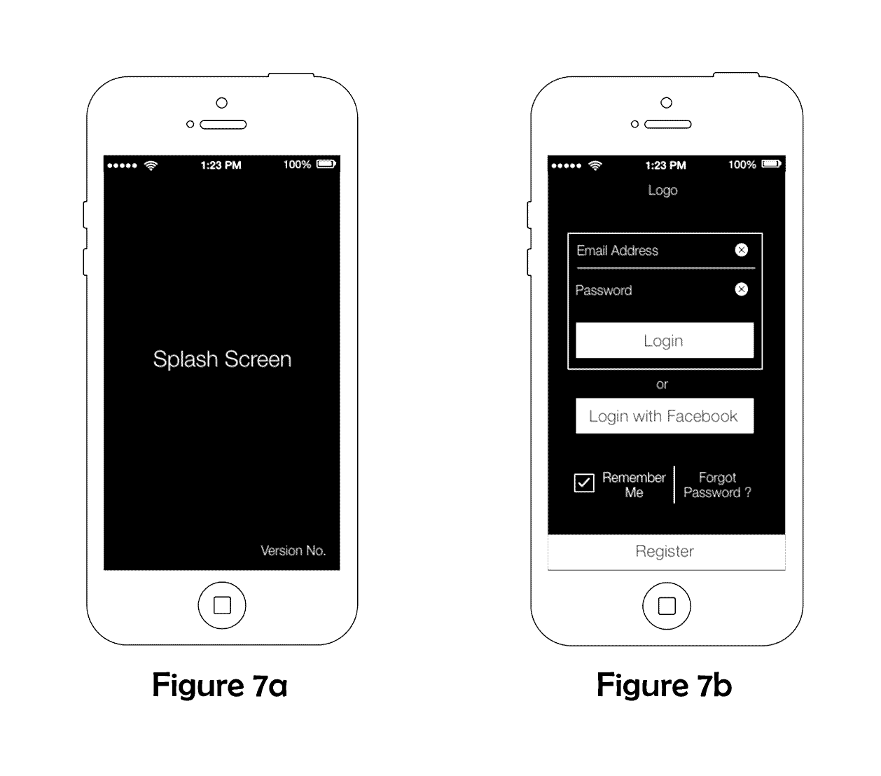

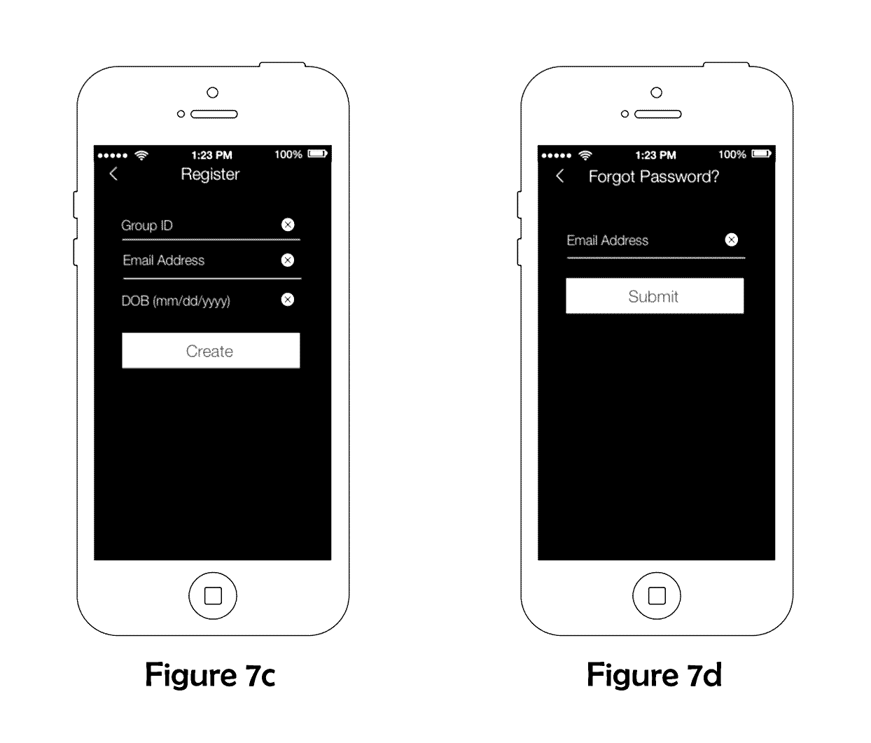

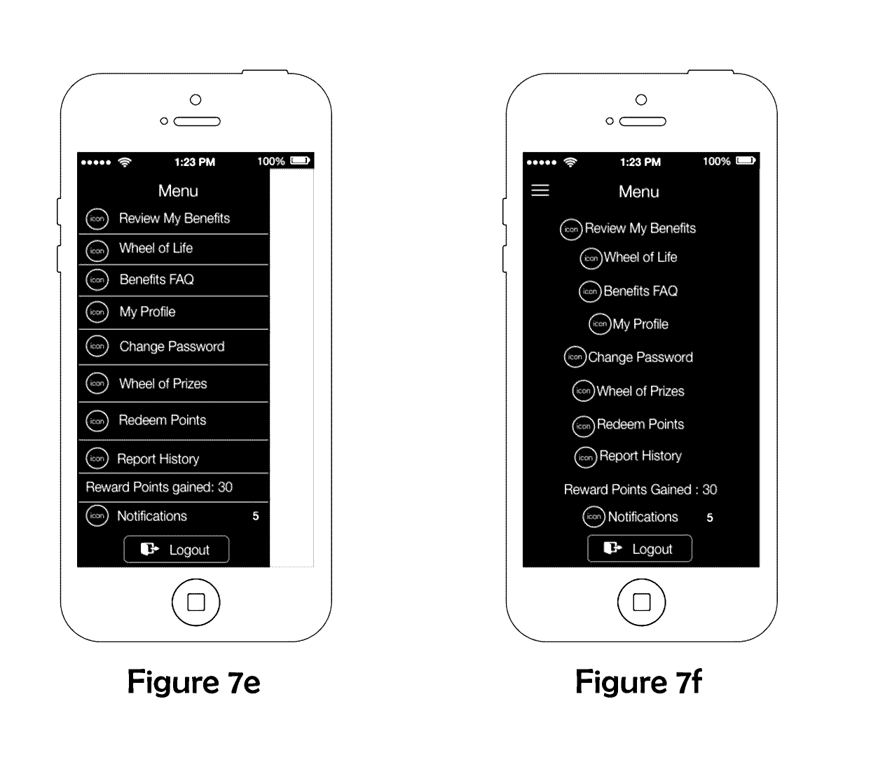

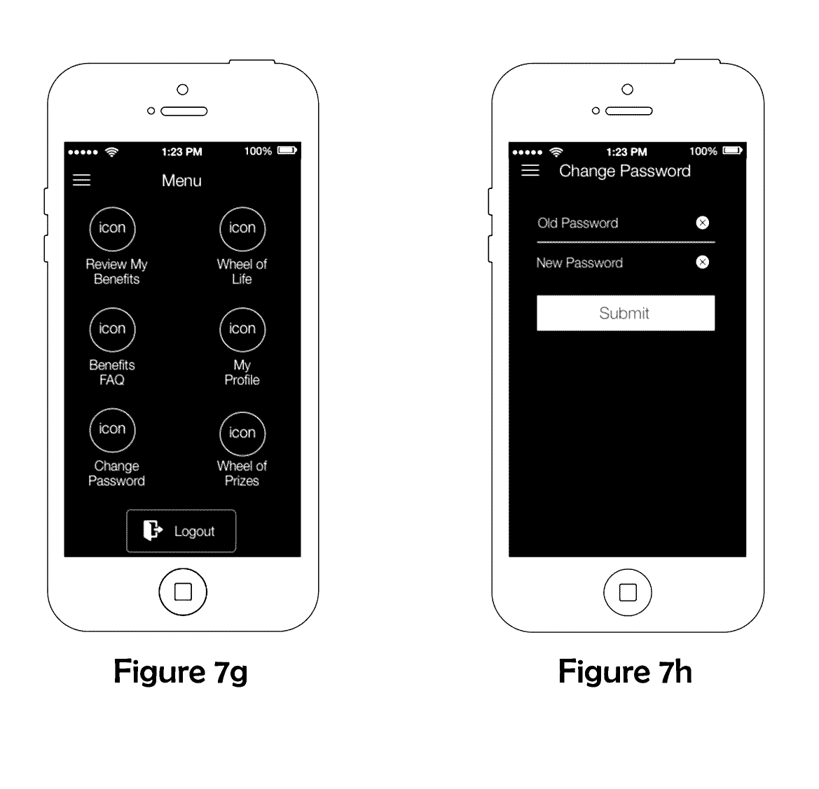

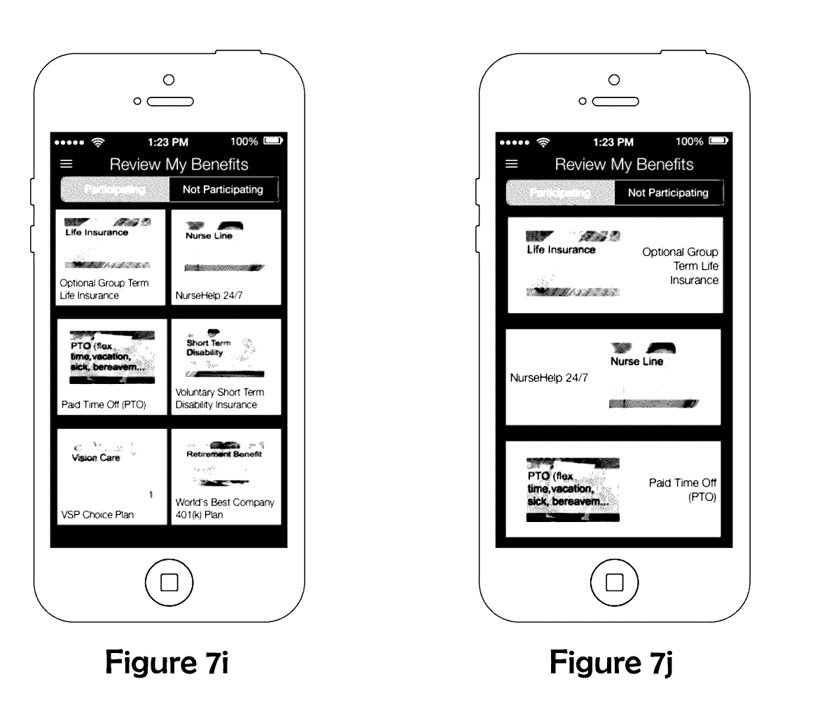

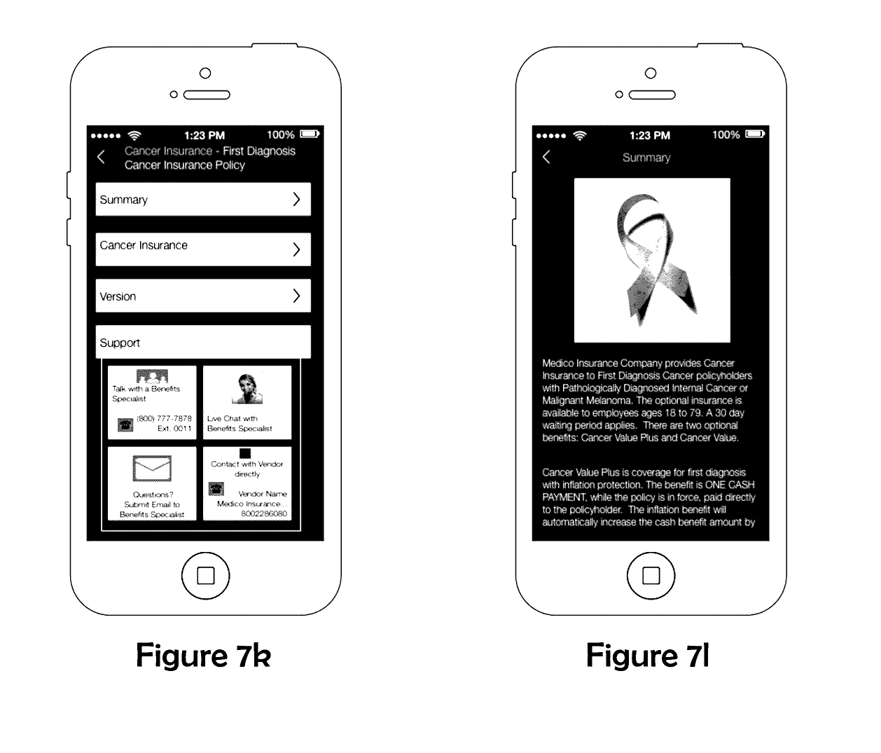

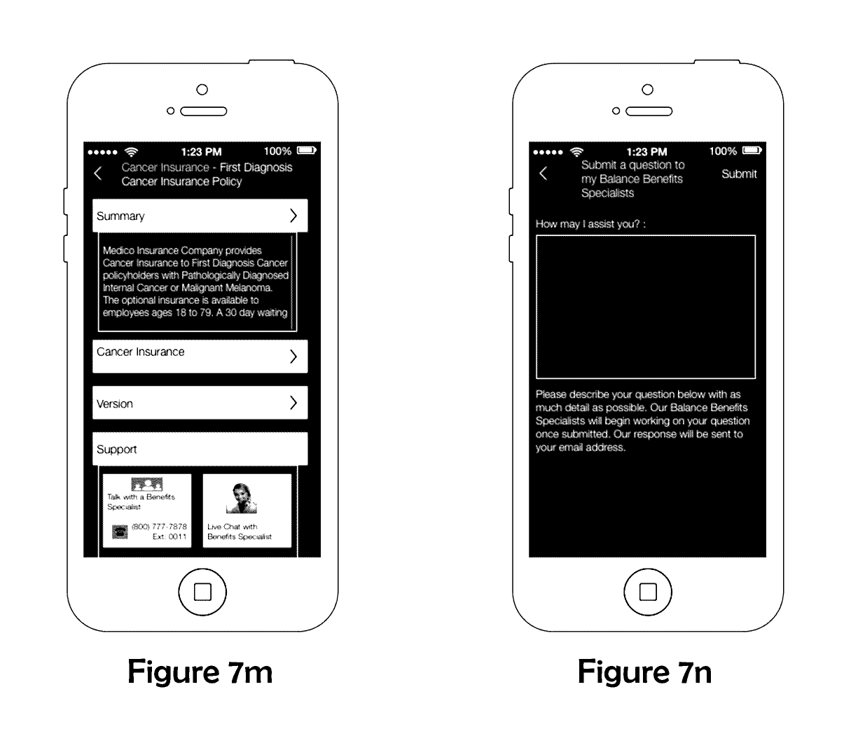

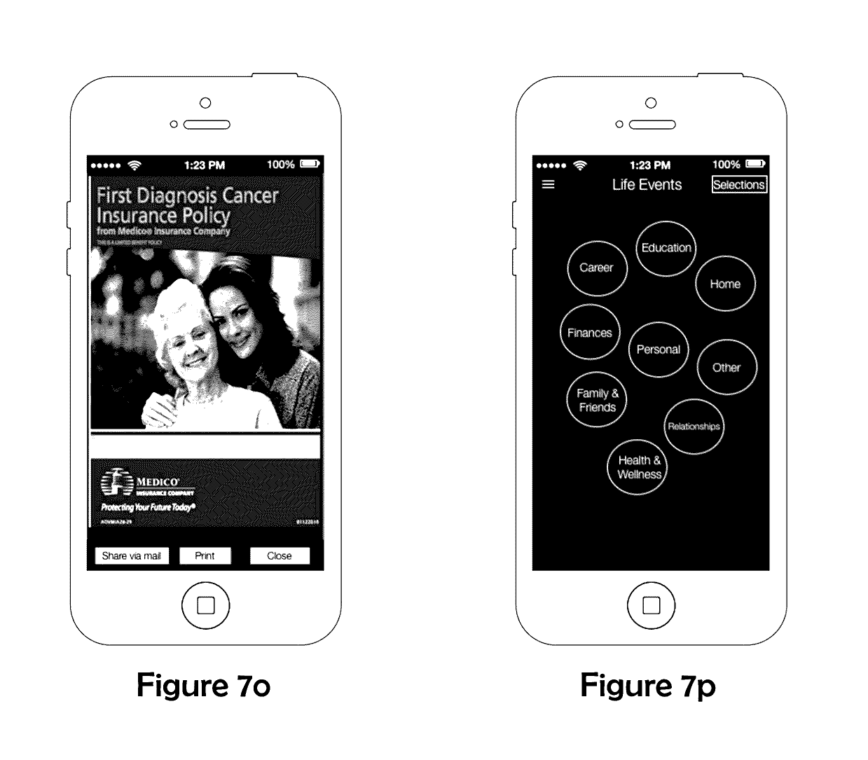

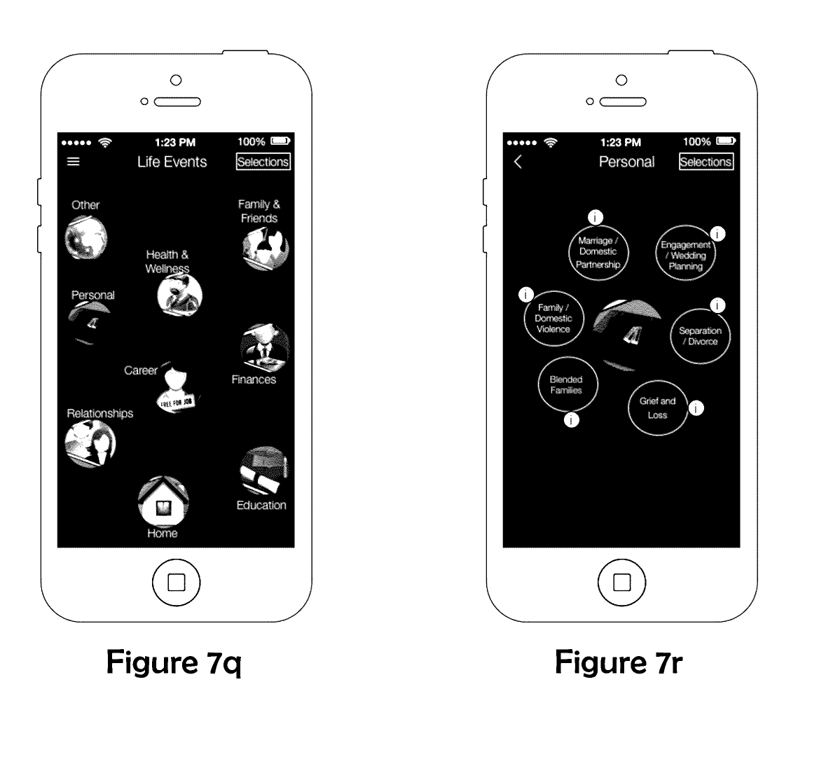

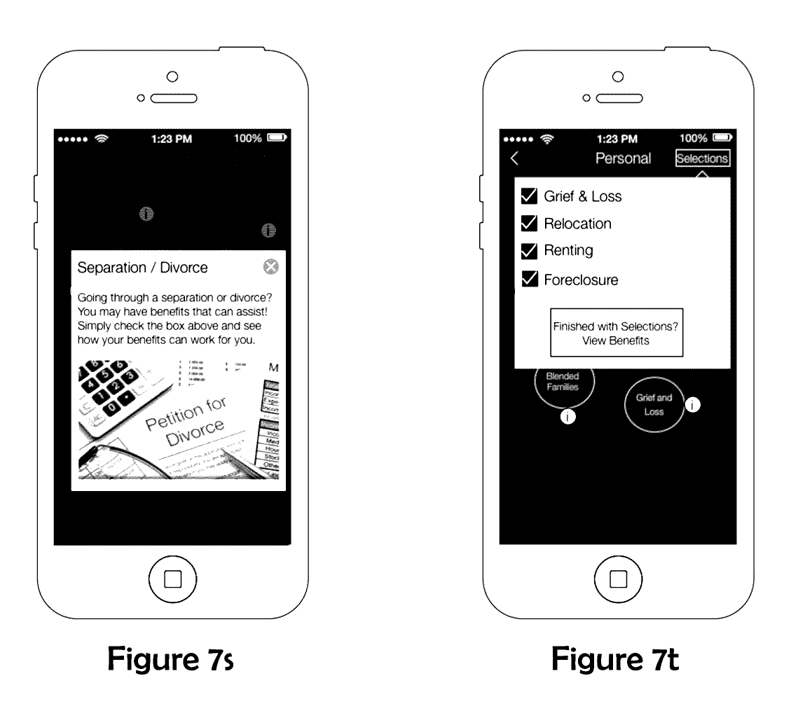

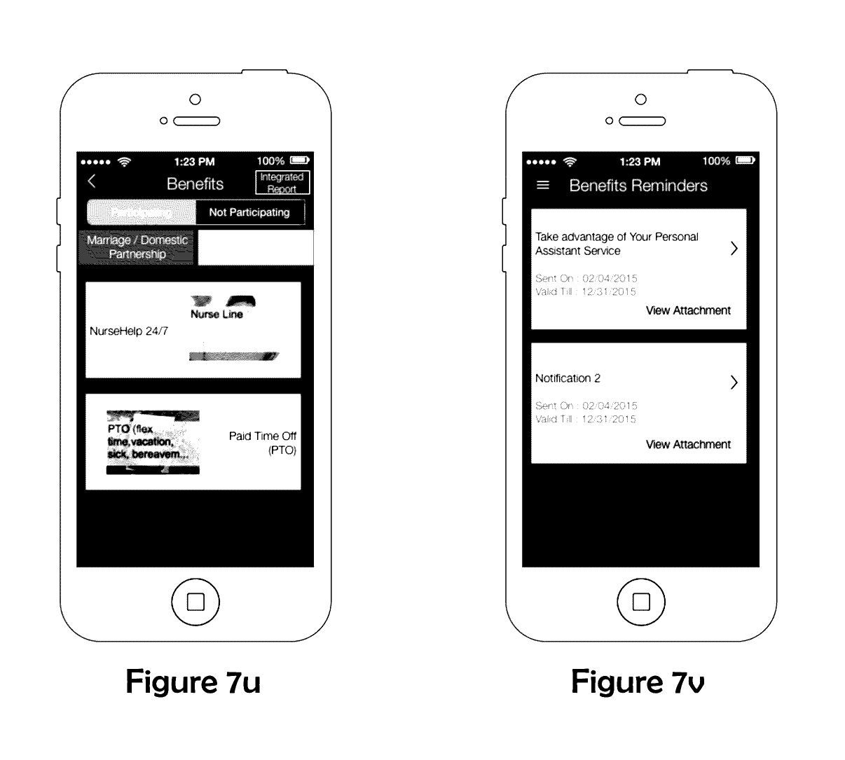

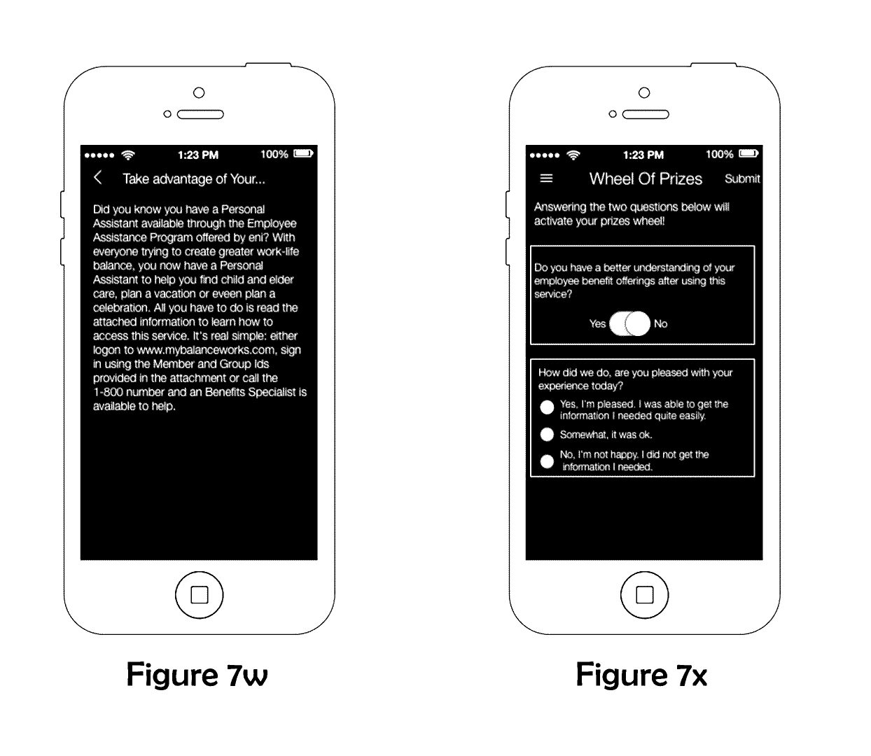

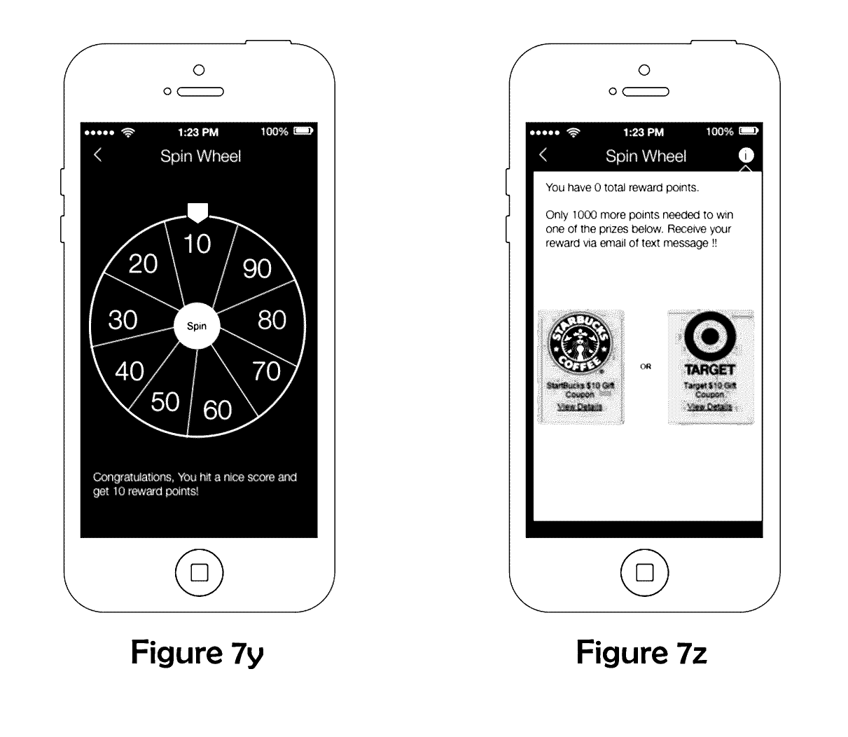

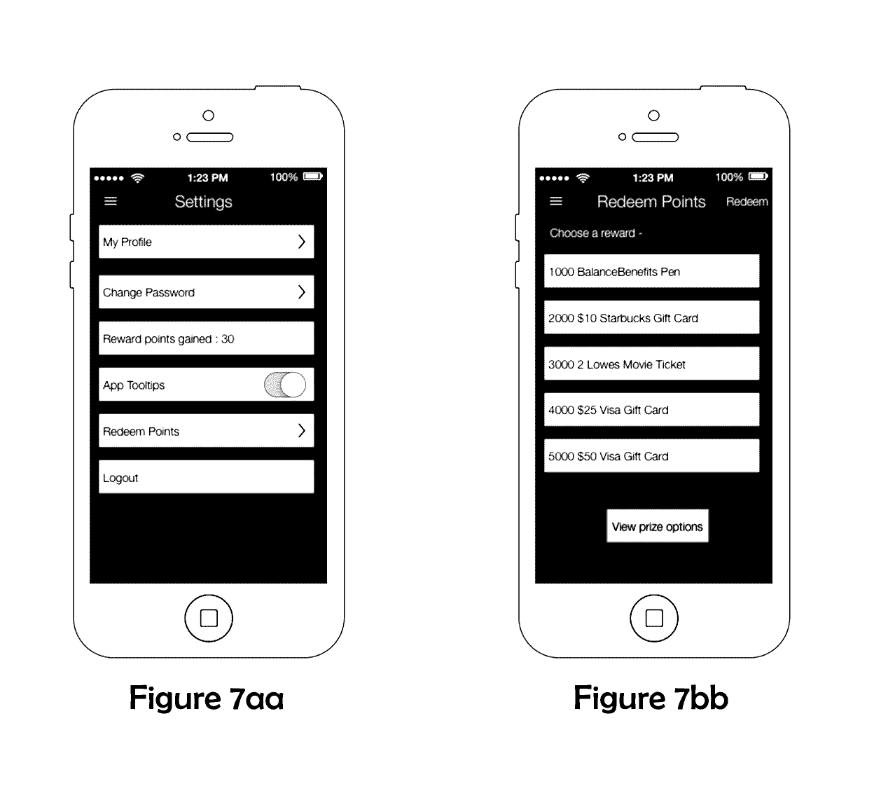

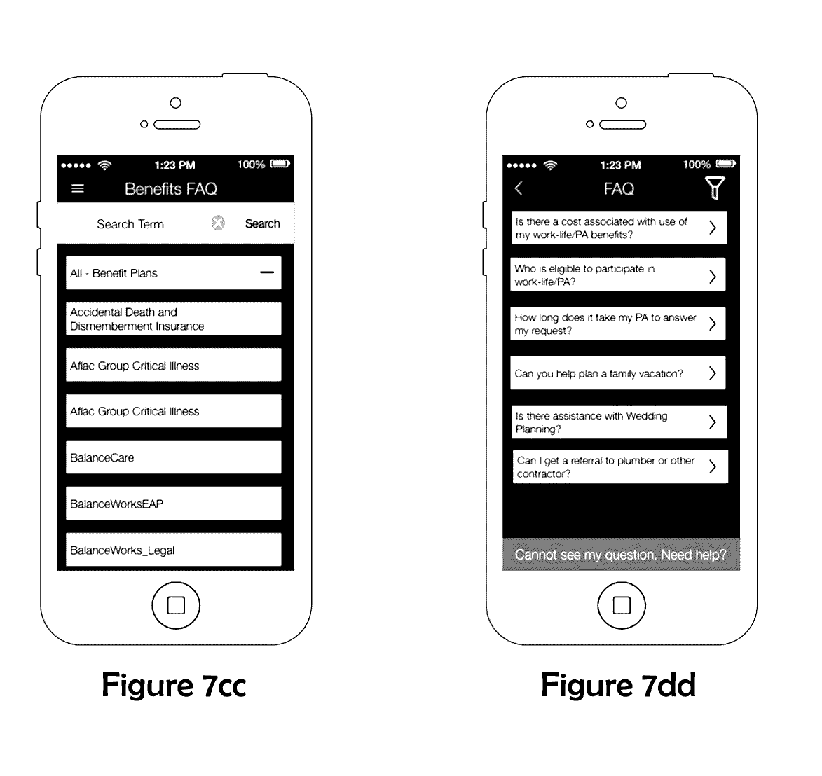

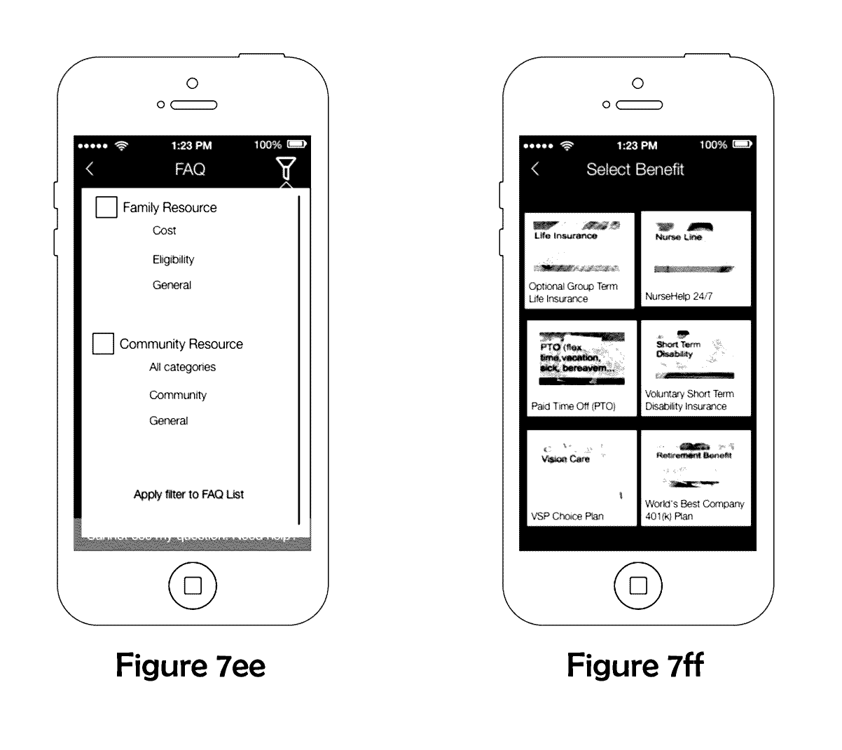

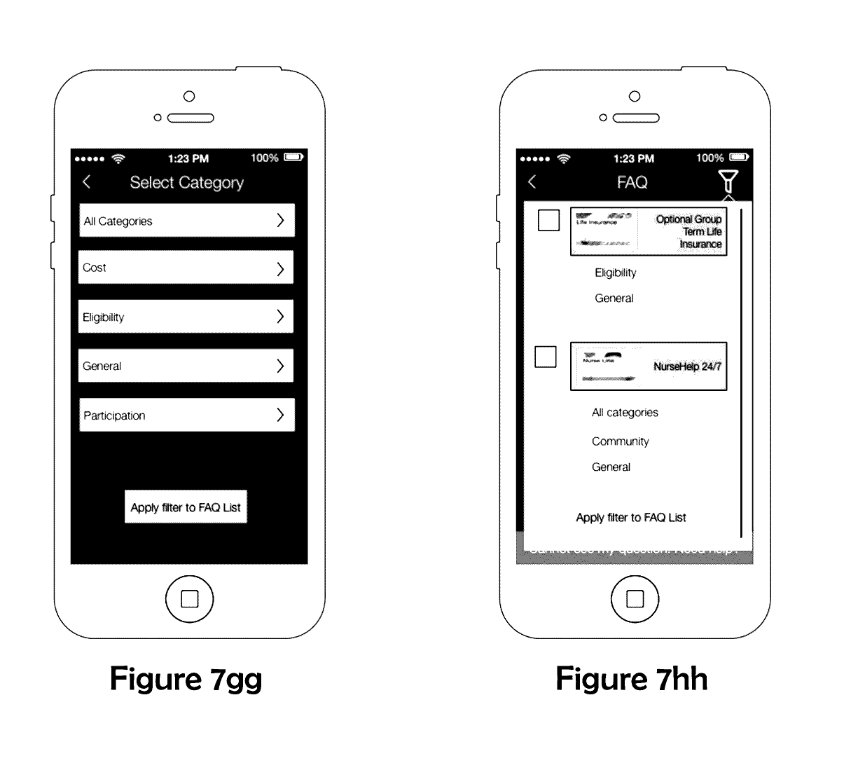

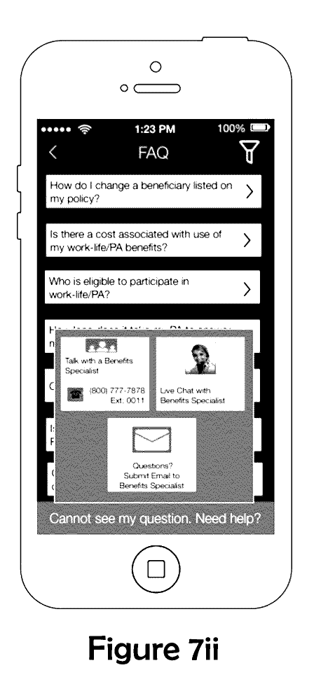

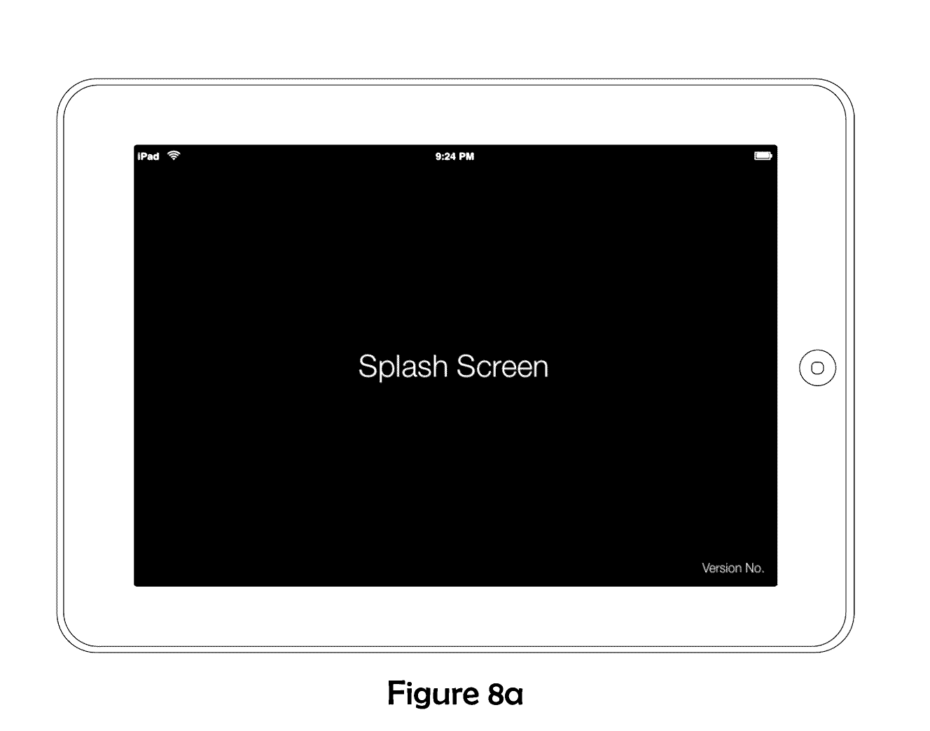

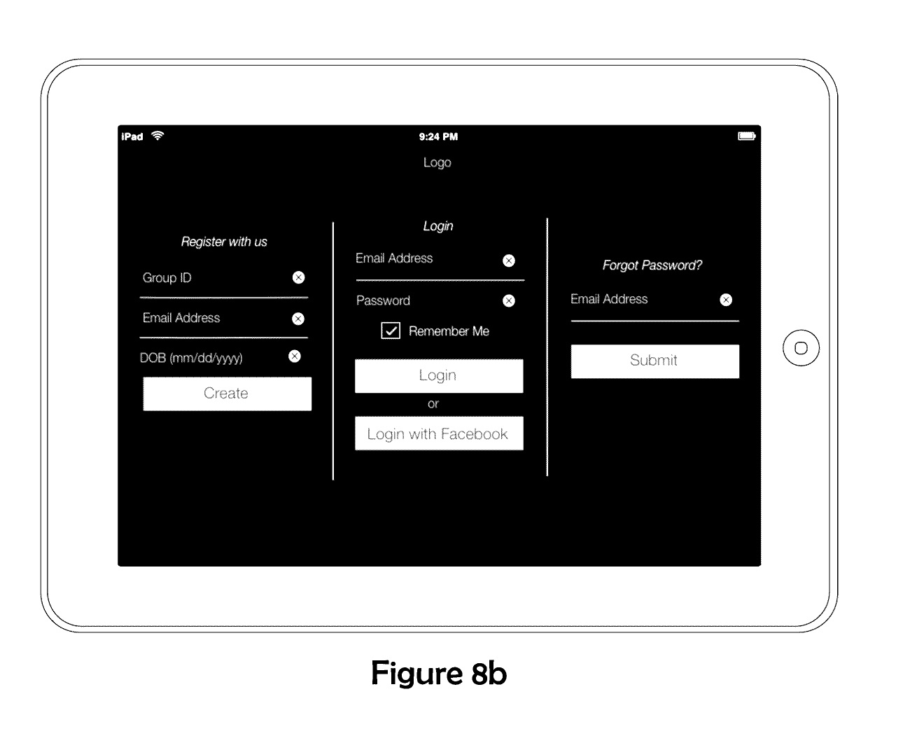

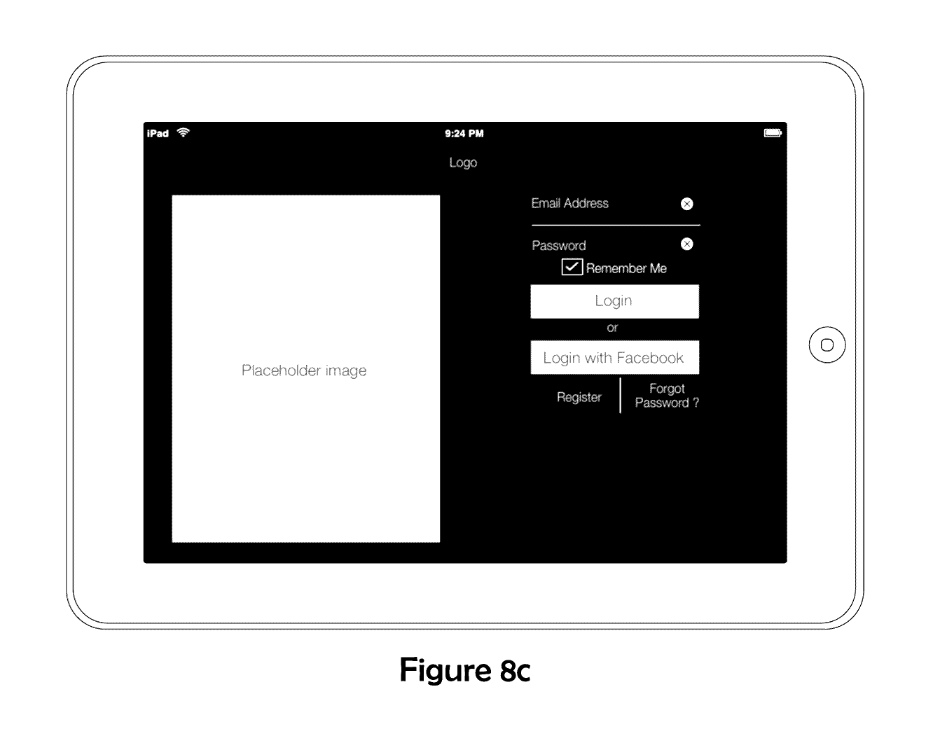

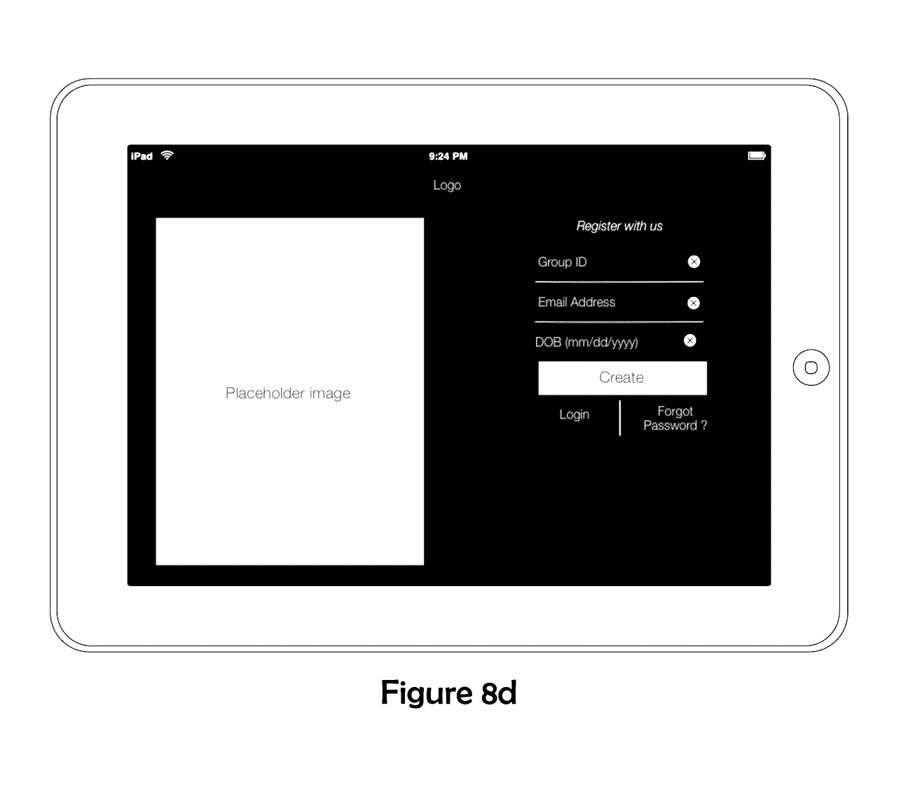

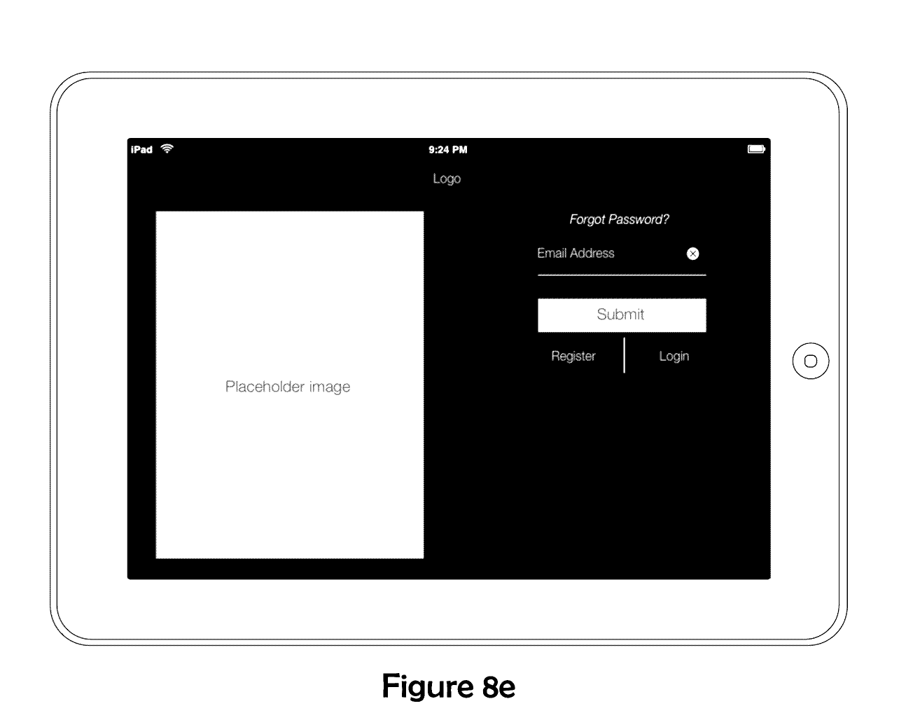

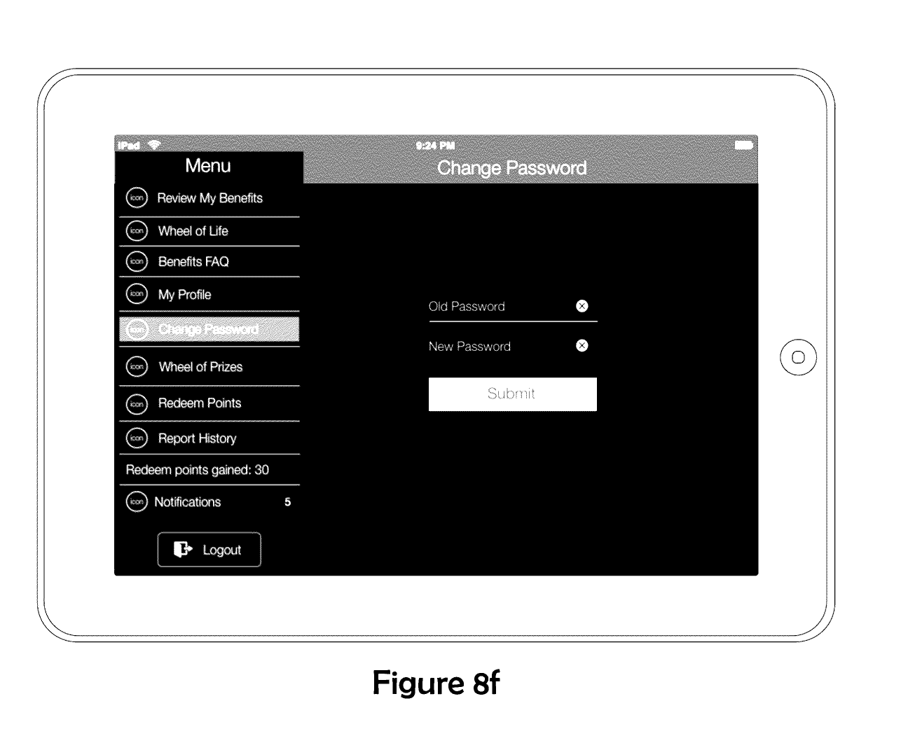

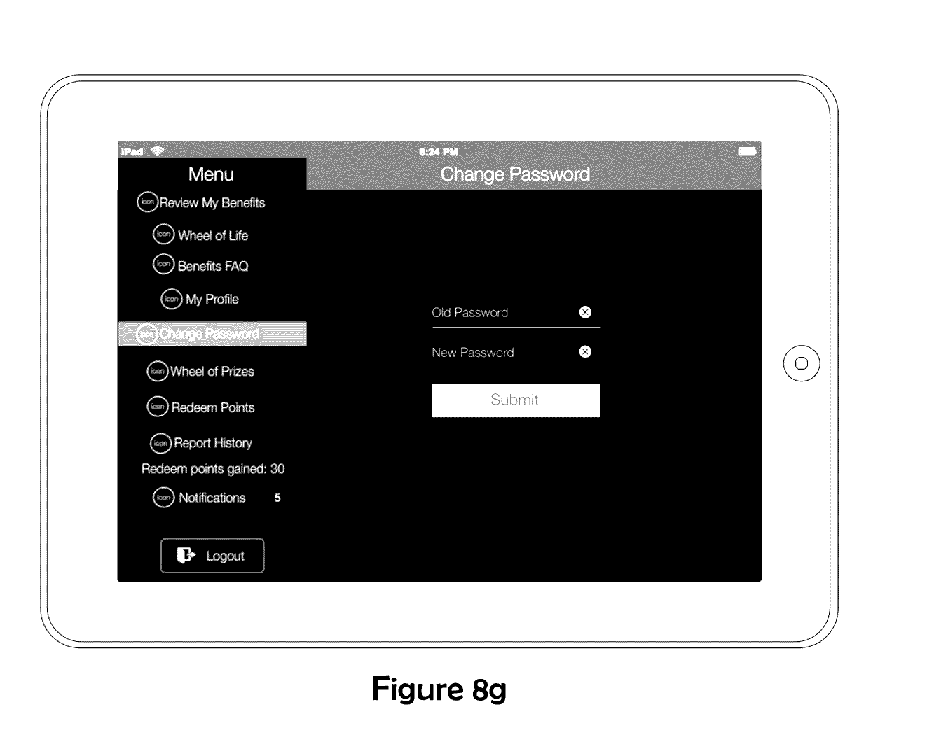

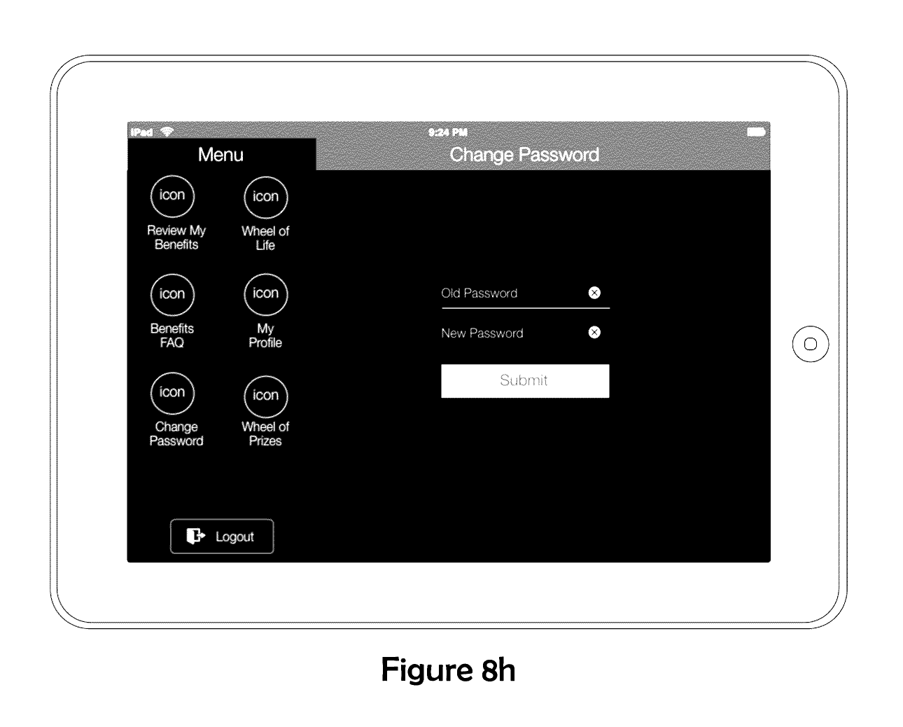

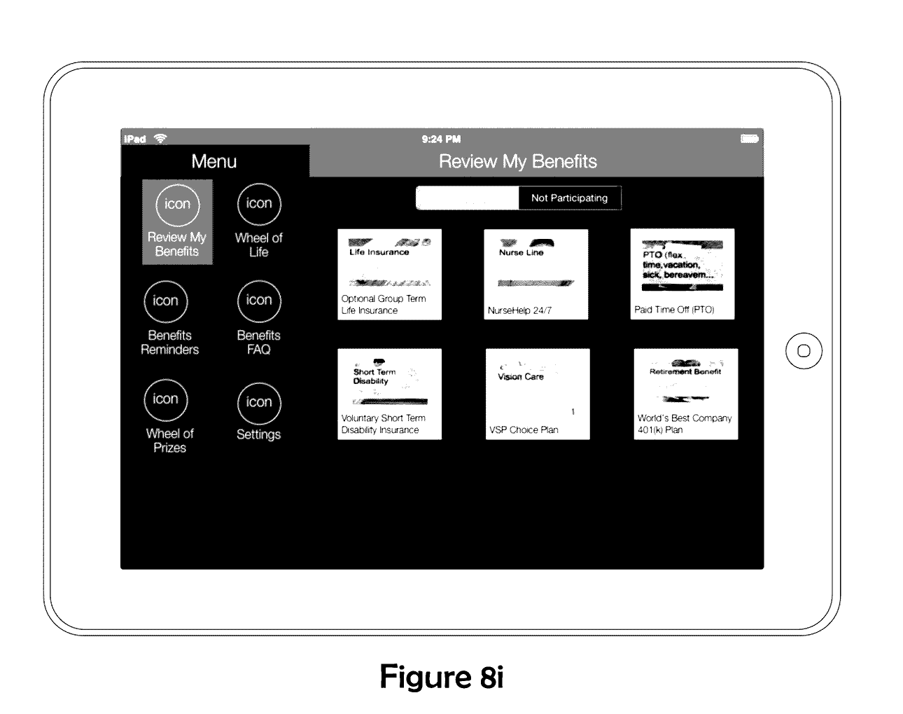

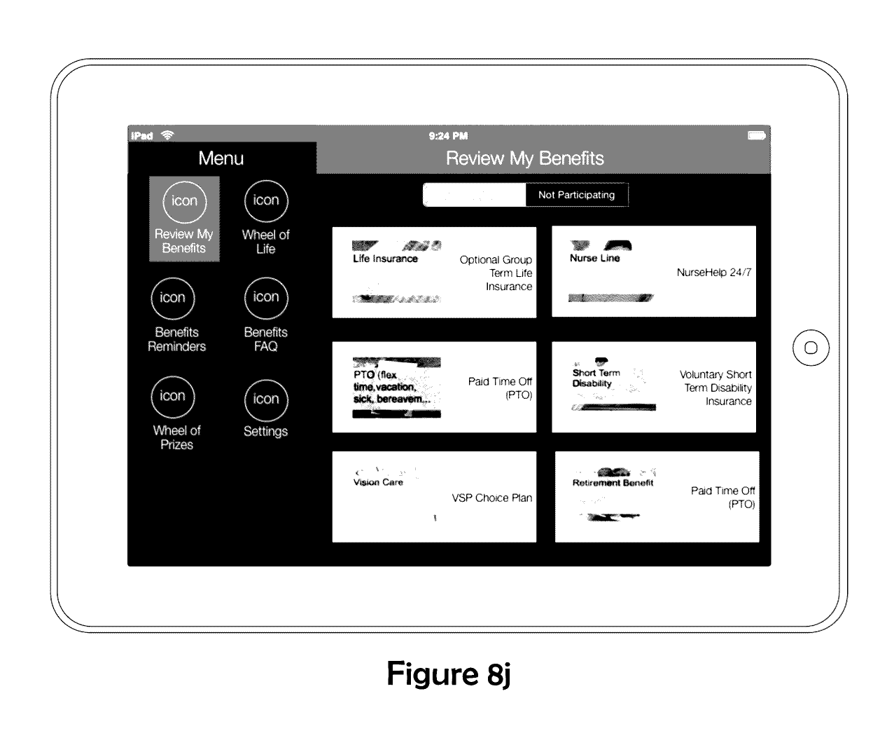

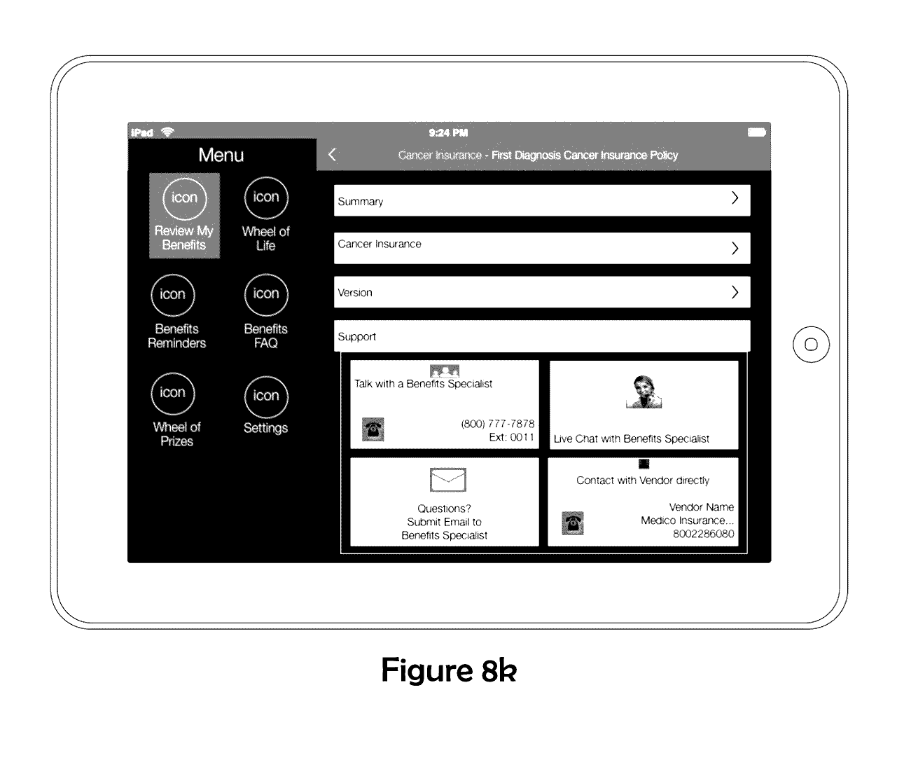

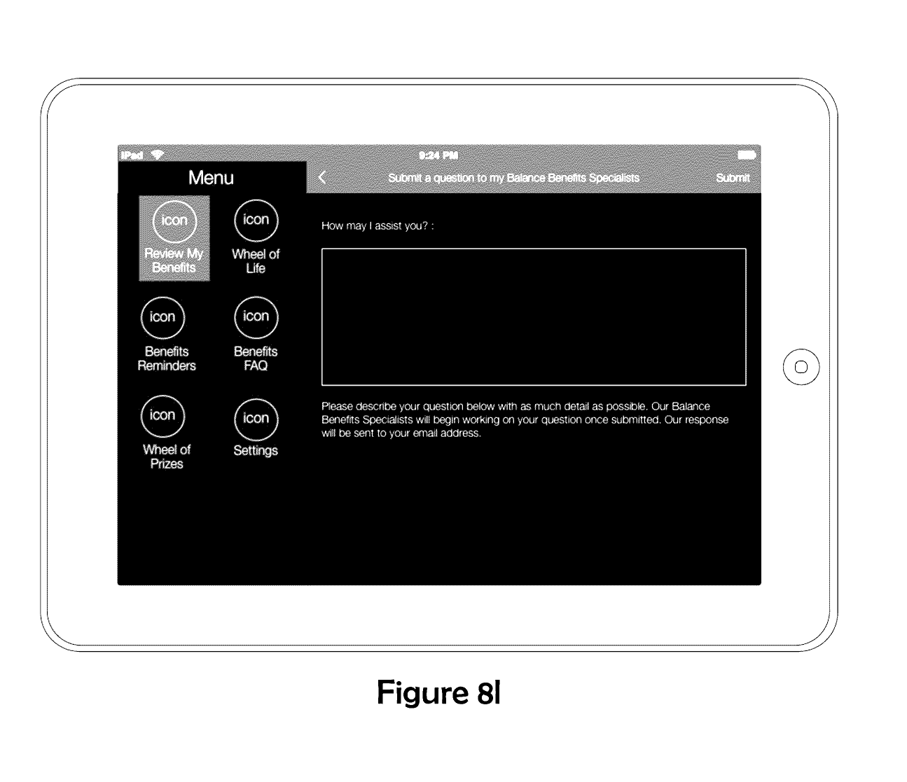

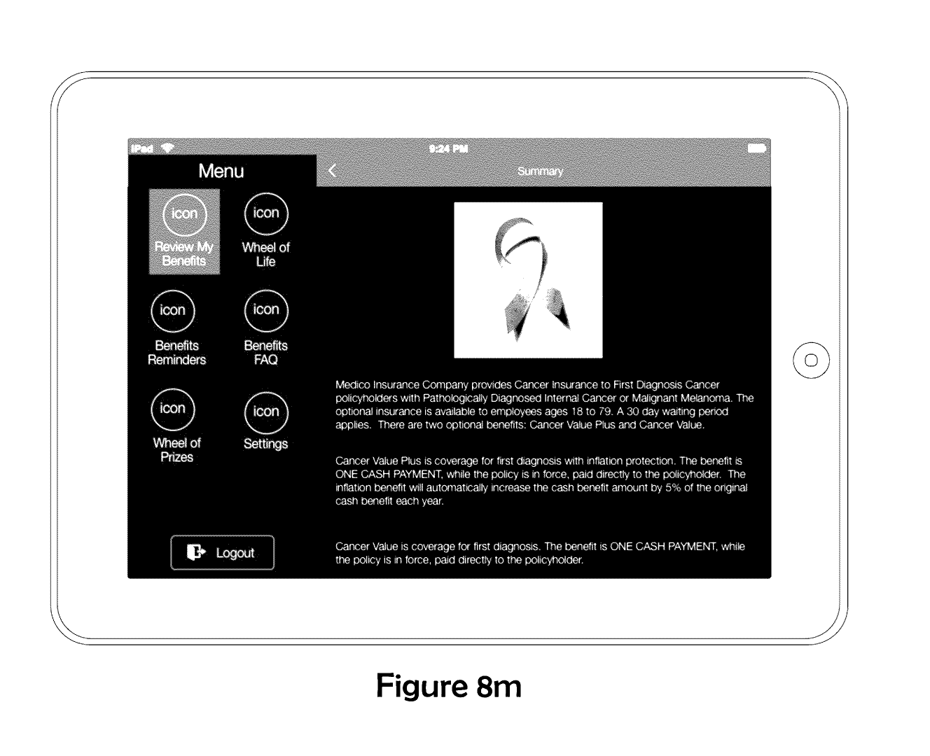

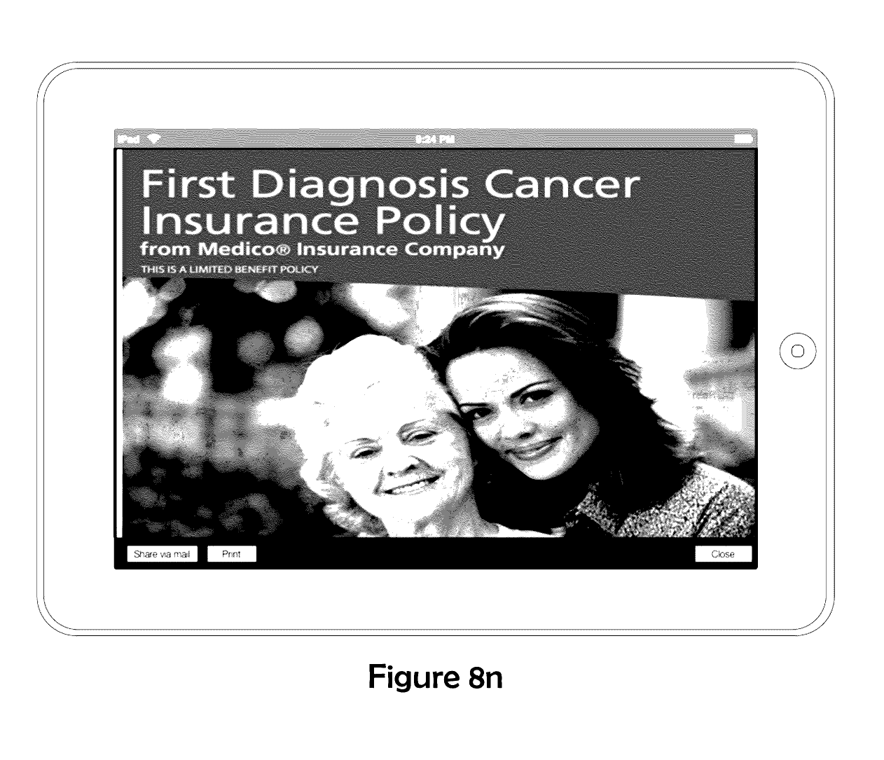

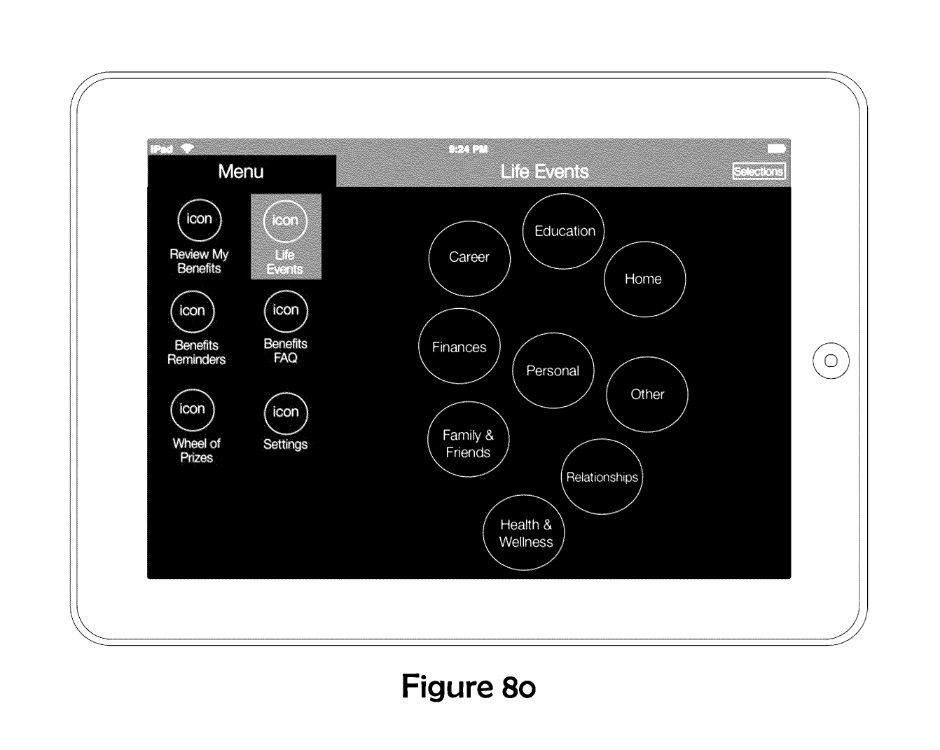

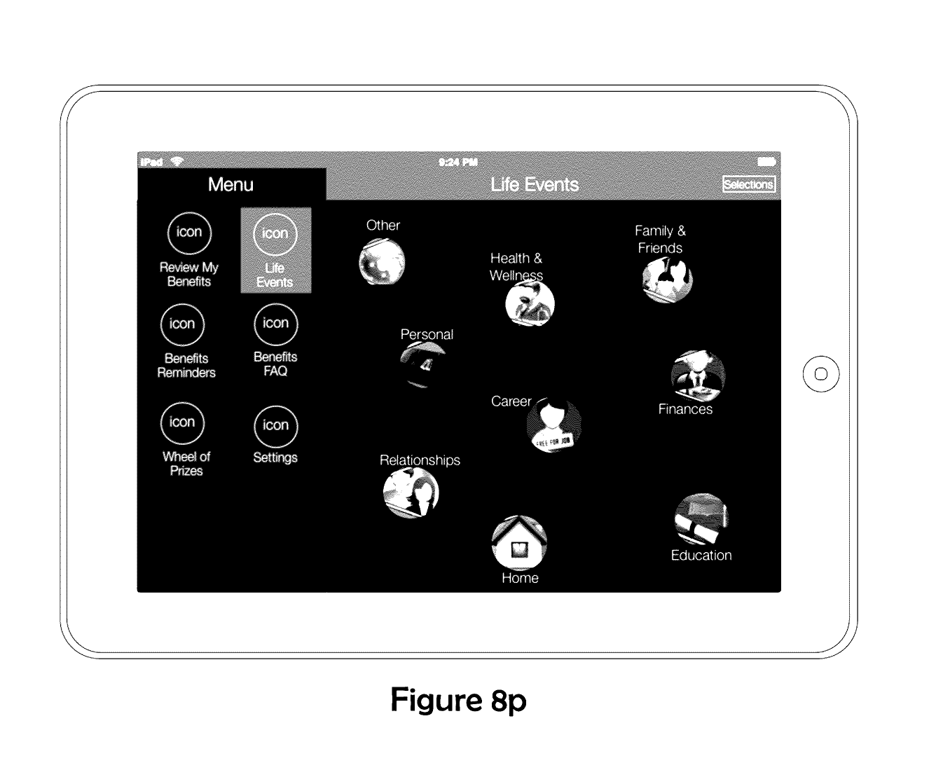

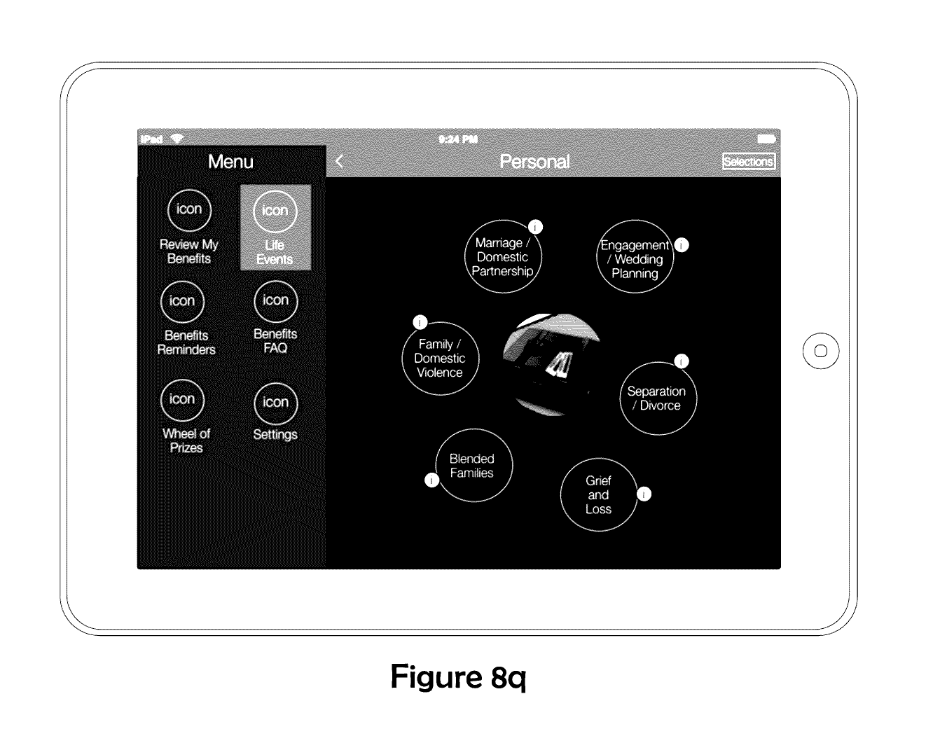

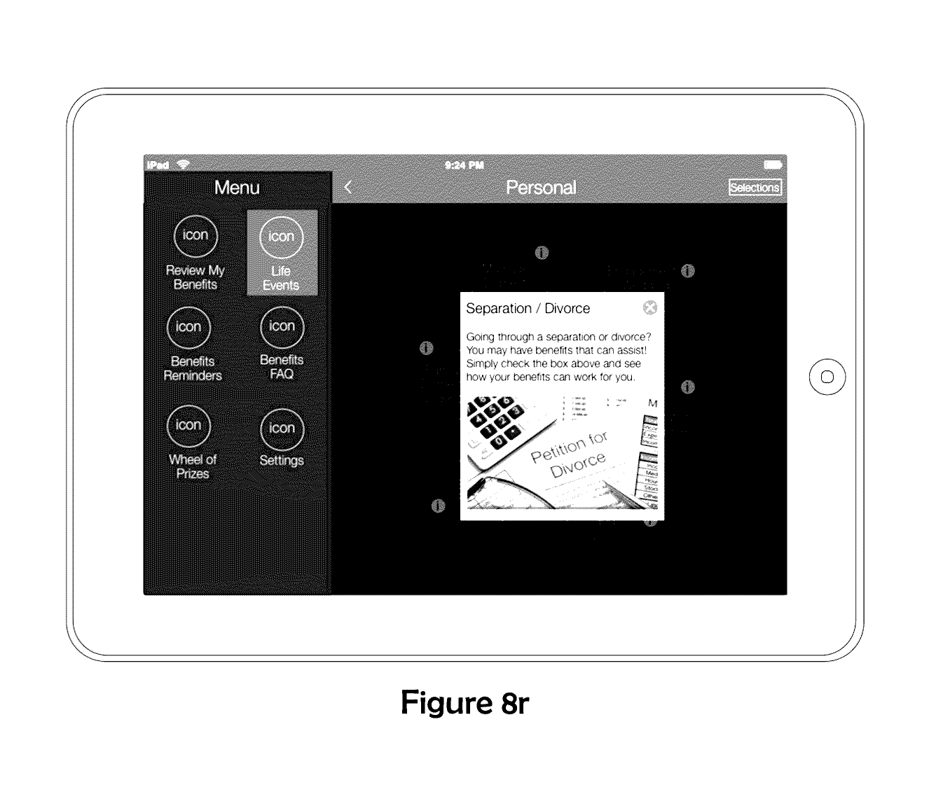

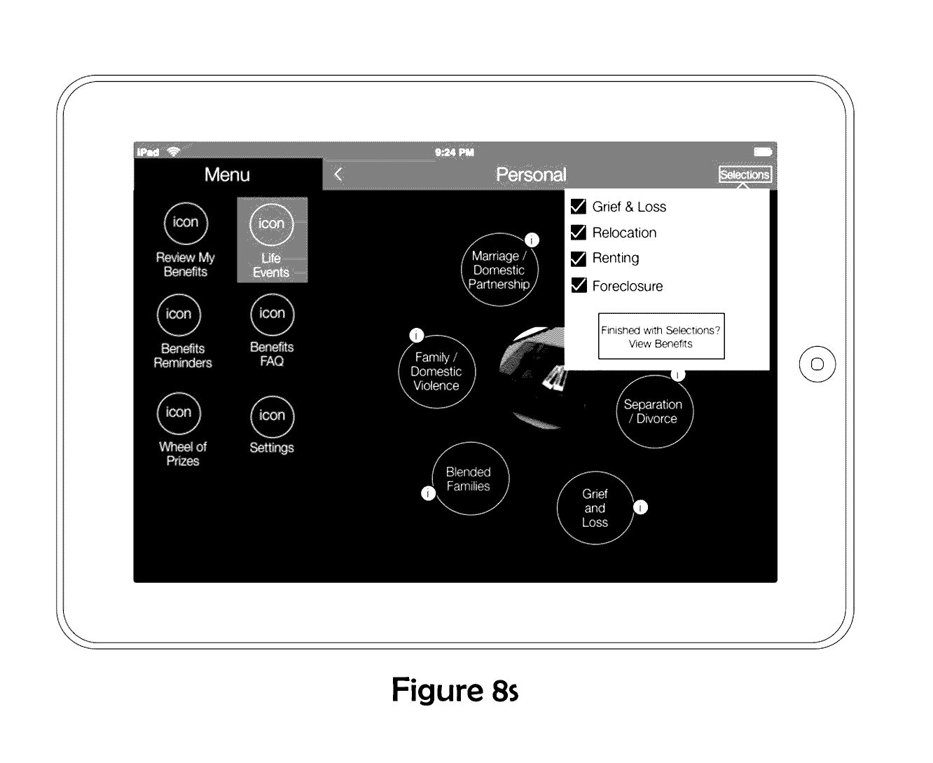

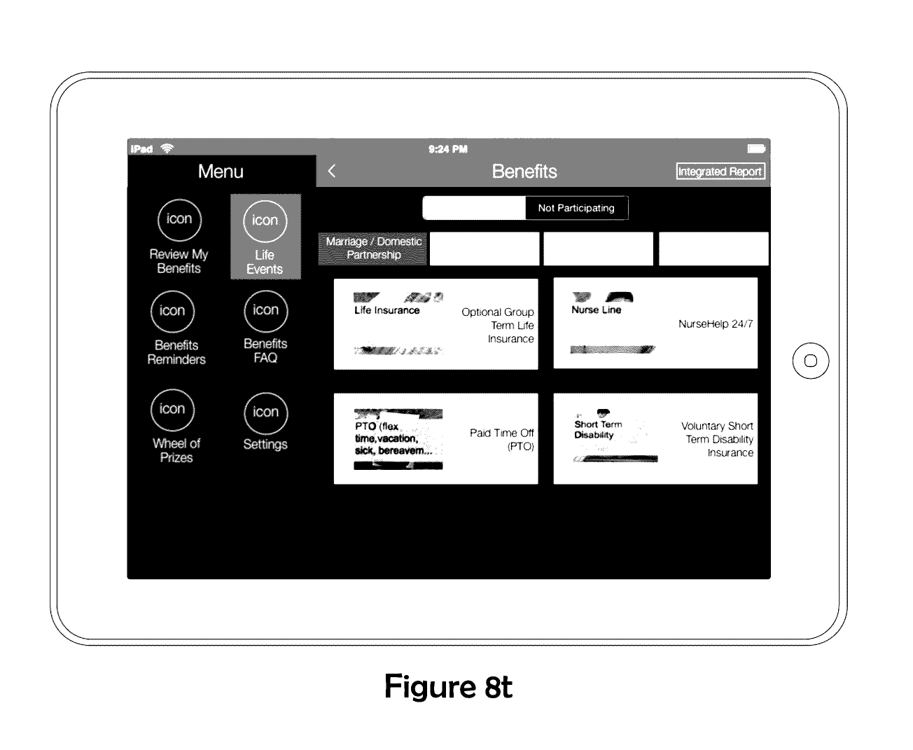

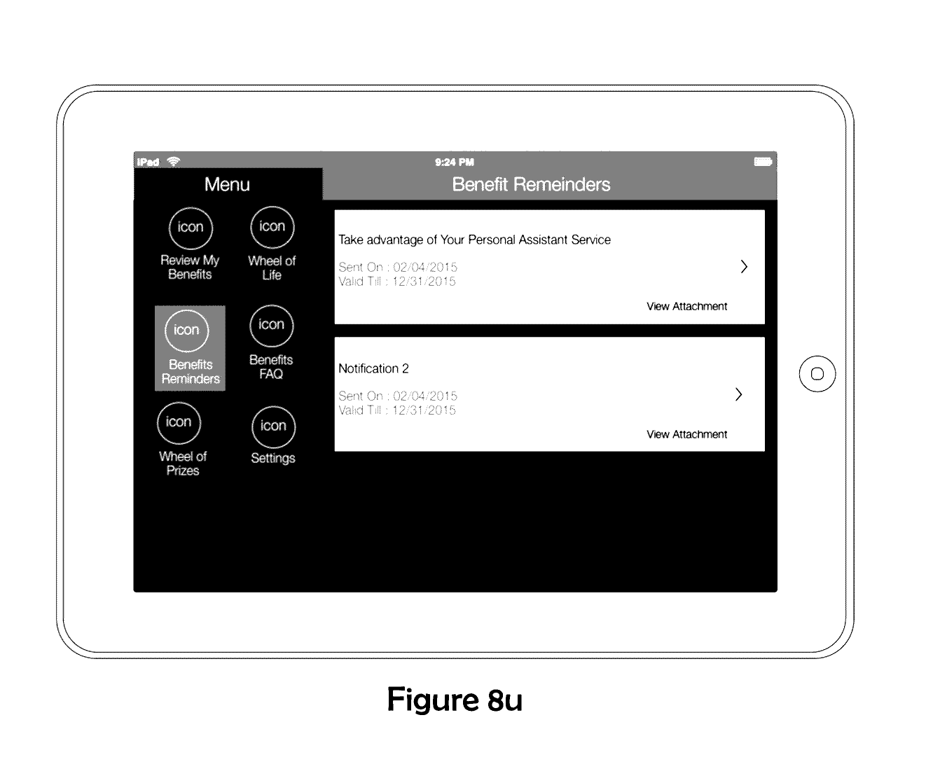

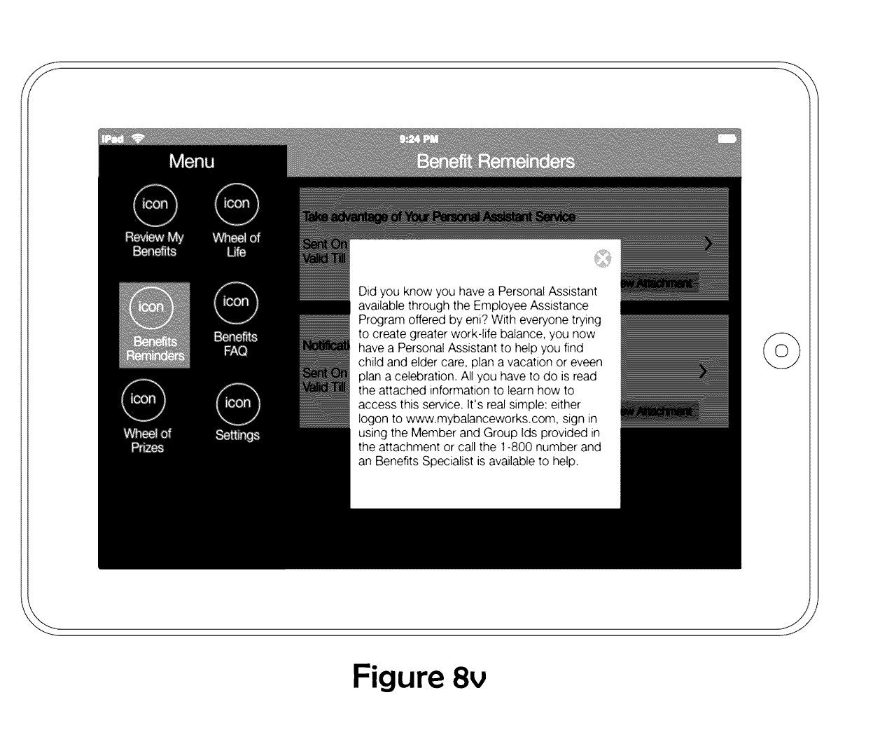

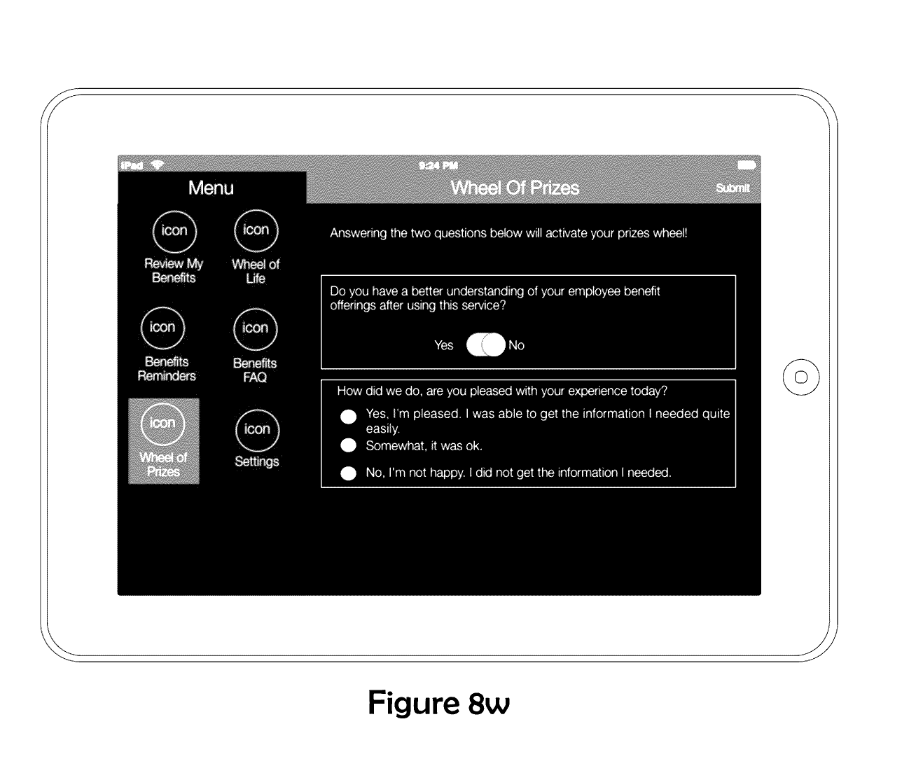

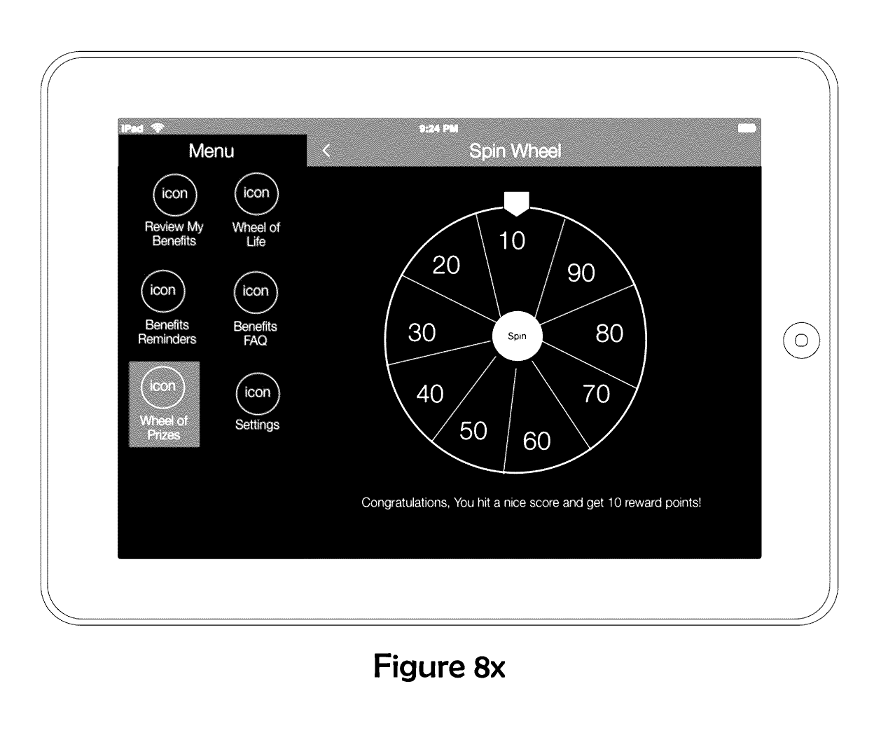

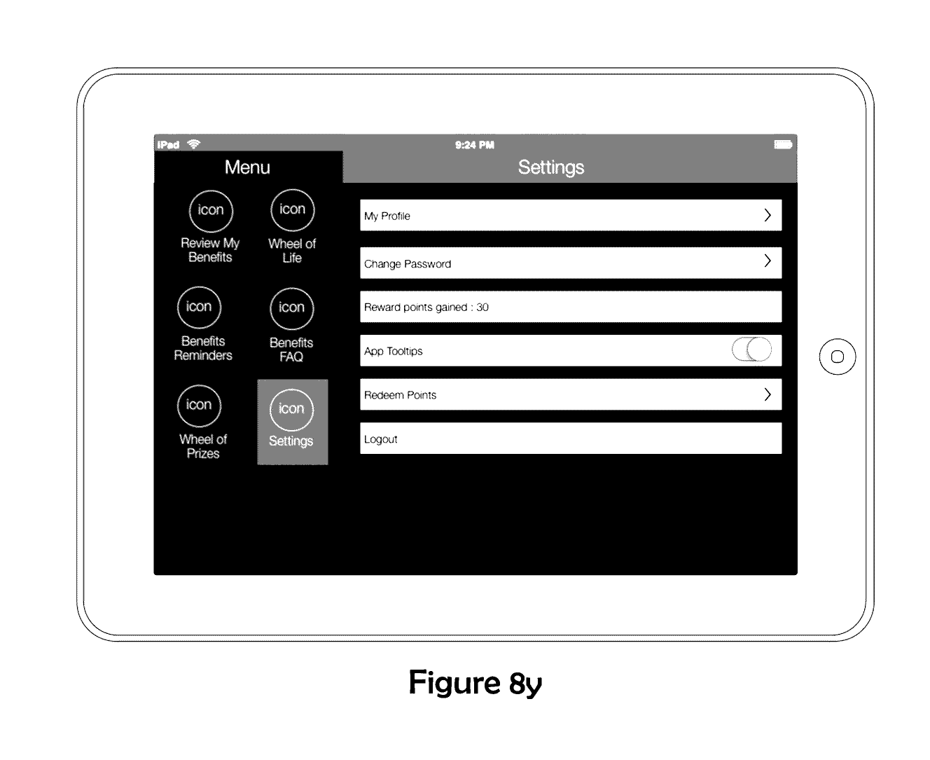

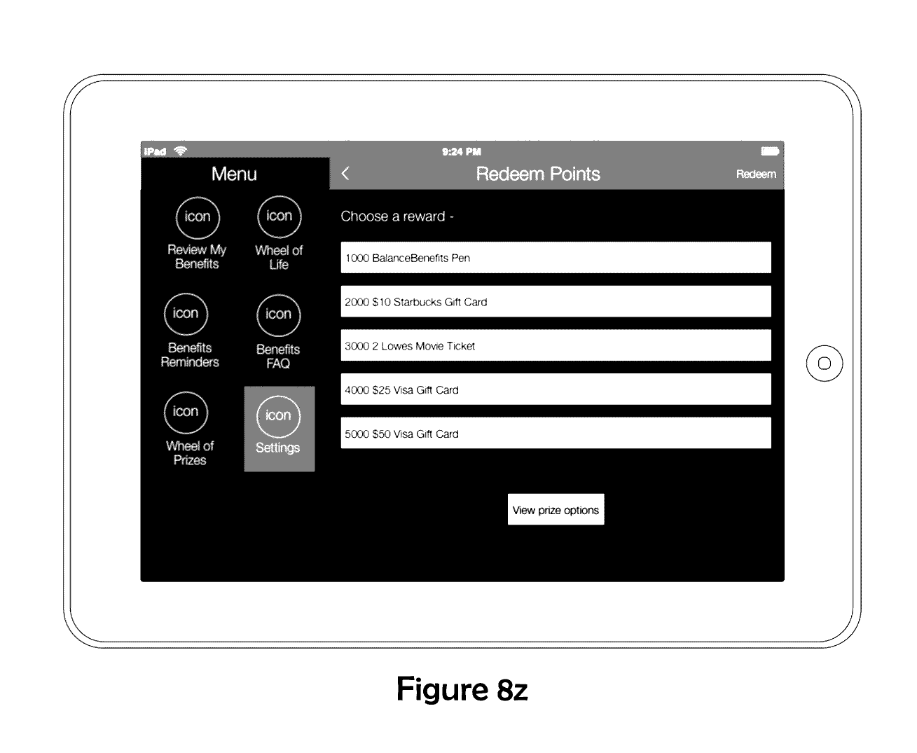

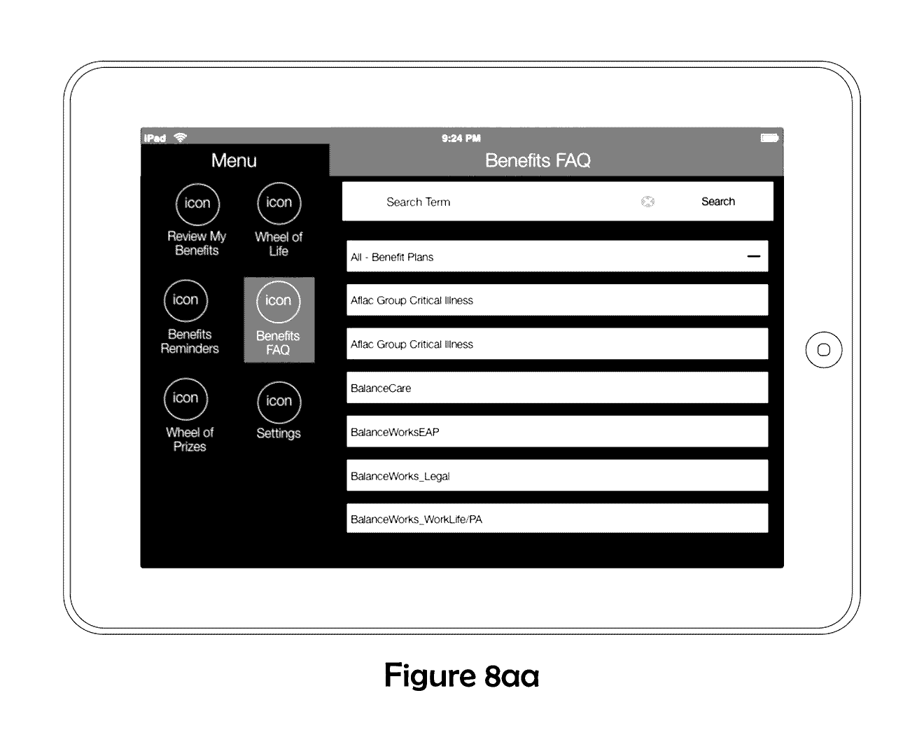

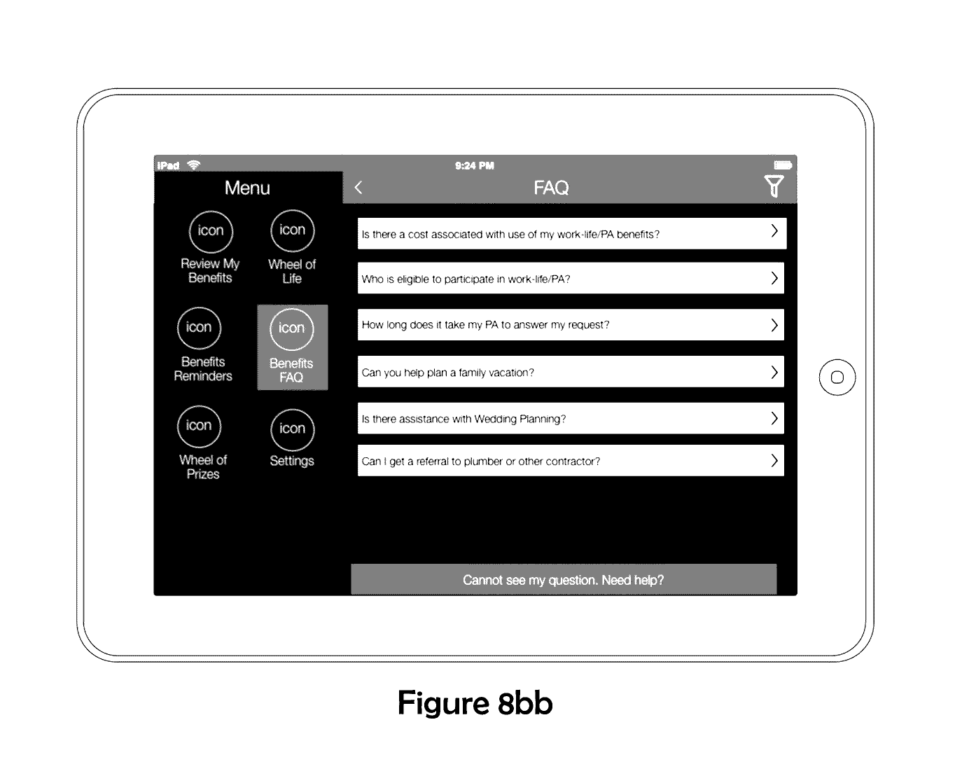

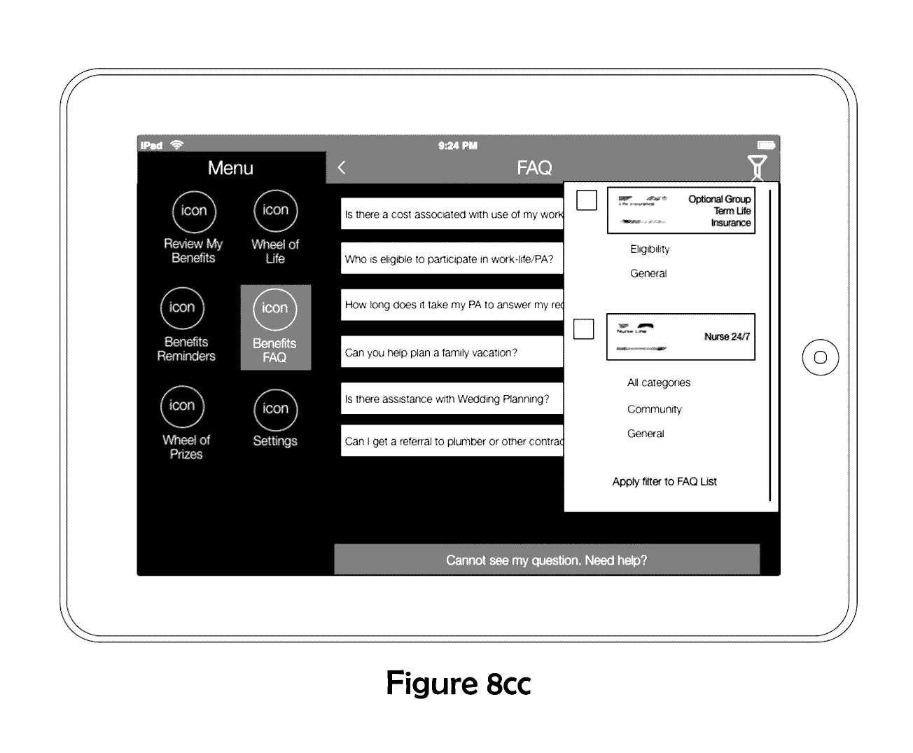

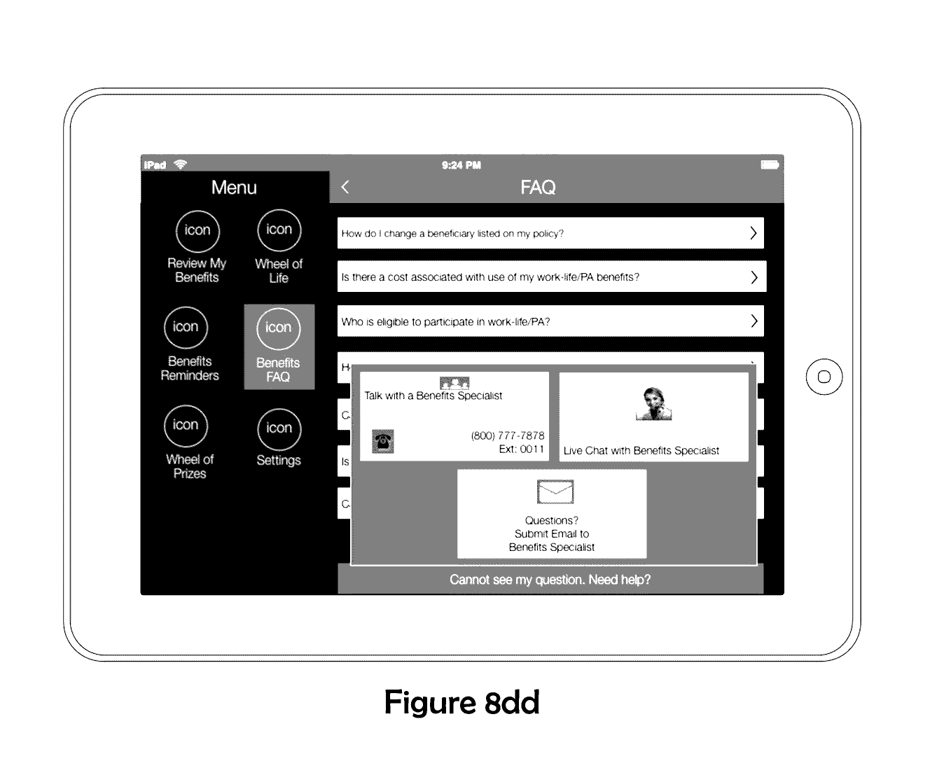

FIGS. 7a through 7ii and 8a through 8dd are screen shots of a mobile application which connects users with their benefit information, provides answers to FAQs, offers a gamified Wheel of Life inventorying users about their life events, creates an Integrated Benefits Report linking users to benefits and community resources to address identified life events.

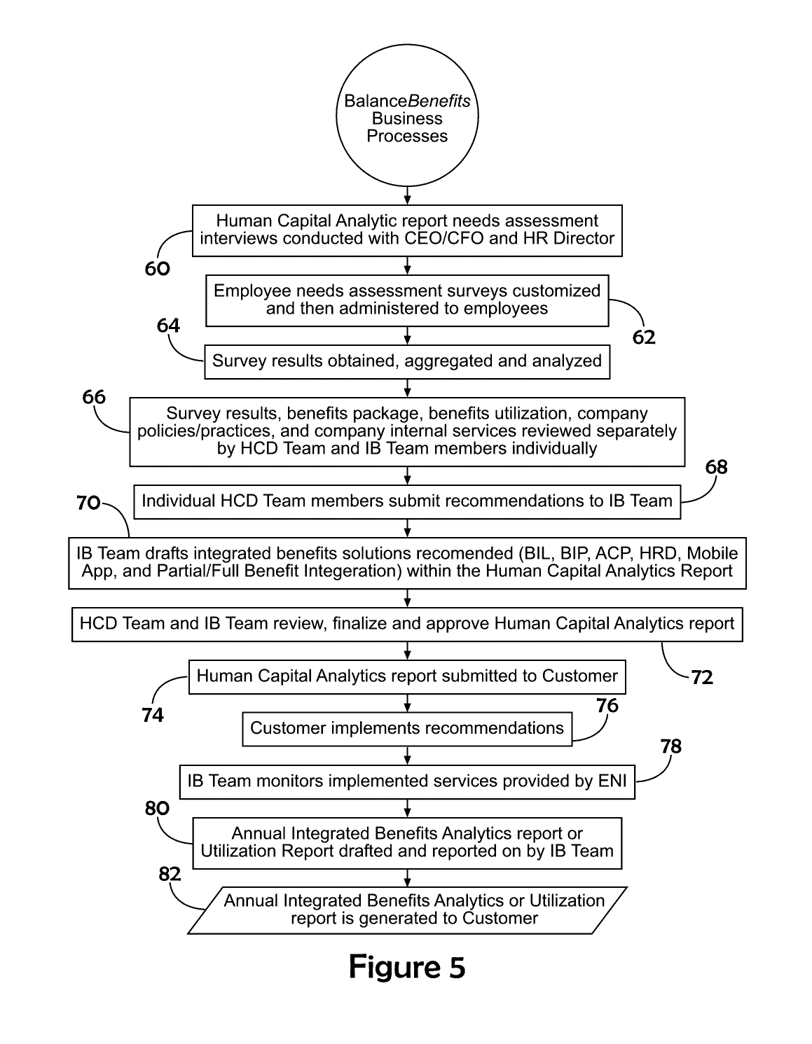

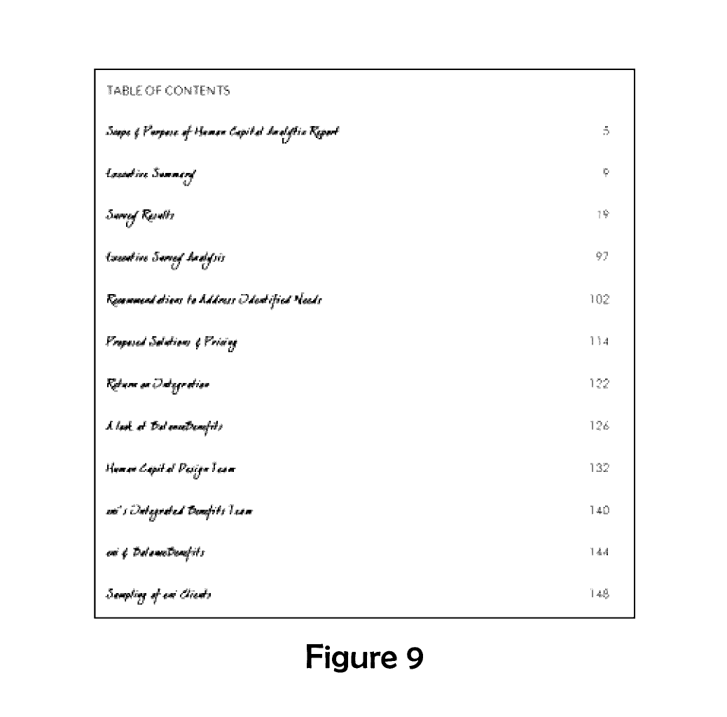

FIG. 9 is a screen shot of a Table of Contents for a Human Capital Analytics Report. The process for creating a Human Capital Analytics Report is described in FIG. 5. A full copy of the Human Capital Analytics Report together with the surveys administered are attached separately.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A system for counseling employees and employers with regard to employer benefits, with one aspect of said system having a processor with associated memory storage device and a computer display operatively connected thereto, said system comprising:
a) a wheel of life graphic displayed on said computer display, said wheel of life comprising a plurality of life event categories, each of said categories being annotated with text, and customized to a specified user; and
b) a first database of benefits and community resources stored in said memory storage device, said benefits provided by an employer for said specified user, whereby at least a portion of said benefits and community resources are linked to each of said life event categories.

2. The system for counseling employees and employers with regard to employer benefits in accordance with claim 1, further comprising:
c) a second database of entities stored in said memory storage device, said entities providing external services to support said life events, whereby at least a portion of said benefits and at least a portion of said entities are linked to each of said life event categories.

3. The system for counseling employees and employers with regard to employer benefits in accordance with claim 1, further comprising a plurality of graphics representative of system functions displayed on said computer display.

4. The system for counseling employees and employers with regard to employer benefits in accordance with claim 3, wherein at least one of said plurality of graphics displayed on said computer display changes upon selection by said specified user of one of said wheel of life categories.

5. The system for counseling employees and employers with regard to employer benefits in accordance with claim 1, wherein said specified user can discover specific benefits that can apply to said user.

6. The system for counseling employees and employers with regard to employer benefits in accordance with claim 1, wherein said specified user can discover employee programs in which said user is not participating.

7. The system for counseling employees and employers with regard to employer benefits in accordance with claim 1, further comprising incentives for said specified user to use said system.

8. The system for counseling employees and employers with regard to employer benefits in accordance with claim 1, further comprising a plurality of documents associated with said benefits and at least a portion of said life event categories is linked to relevant ones of said plurality of documents.

9. In a system for counseling employees and employers with regard to employer benefits, said system having a processor with associated memory storage device and a computer display operatively connected thereto, the improvement comprising:
a wheel of life graphic displayed on said computer display, said wheel of life comprising a plurality of life event categories, each of said categories being annotated with text, and customized to a specified user.

10. The system for counseling employees and employers with regard to employer benefits in accordance with claim 9, further comprising:
two databases, the first of said databases containing data representative of benefits stored in said memory storage device, said benefits provided by an employer for said specified user, whereby at least a portion of said benefits is linked to each of said life event categories of entities stored in said memory storage device, and said second of said databases containing data representative of entities providing external services to support said life events, whereby at least a portion of said benefits and at least a portion of said entities are linked to each of said life event categories.

11. The system for counseling employees and employers with regard to employer benefits in accordance with claim 9, further comprising a plurality of graphics representative of system functions displayed on said computer display.

12. The system for counseling employees and employers with regard to employer benefits in accordance with claim 10, wherein at least one of said plurality of graphics displayed on said computer display changes upon selection by said specified user of one of said wheel of life categories.

13. The system for counseling employees and employers with regard to employer benefits in accordance with claim 9, wherein said specified user can discover specific benefits that can apply to said user.

14. The system for counseling employees and employers with regard to employer benefits in accordance with claim 9, wherein said specified user can discover employee programs in which said user is not participating.

15. The system for counseling employees and employers with regard to employer benefits in accordance with claim 9, further comprising incentives for said specified user to use said system.

16. The system for counseling employees and employers with regard to employer benefits in accordance with claim 9, further comprising a plurality of documents associated with said benefits and at least a portion of said life event categories is linked to relevant ones of said plurality of documents.

17. The system for counseling employees and employers with regard to employer benefits, in accordance with claim 9, wherein a specified user can access said system through a mobile application.

18. The system for counseling employees and employers with regard to employer benefits, in accordance with claim 9, said system creating employer specific Human Capital Analytics Reports through administering employer specific survey instruments, and analyzing data compiled therefrom.
